(19) United States
(12) Patent Application Publication
(10) Pub. No.: US 2001/0034617 A1
(43) Pub. Date: Oct. 25, 2001

(54) Method for sharing information concerning medical treatment of an individual

(75) Inventor: Yusuke Kimata, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/833,148

(22) Filed: Apr. 11, 2001

(30) Foreign Application Priority Data
Apr. 14, 2000 (JP) P2000-113971

(51) Int. Cl. G06F 17/60

(52) U.S. Cl. 705/3

(57) ABSTRACT

This invention relates to a method for sharing information concerning medical treatment of an individual. The method includes using steps of a network system in which a plurality of hospital terminals, a plurality of user terminals, and a database terminal for managing a database of individual medical treatment information are connected via a communication network, wherein a user acquires a user ID, a user password, a second password, and a space in the database for storing individual medical treatment information, and a hospital acquires individual medical treatment information from the database or saves updated individual medical treatment information in the database using the user ID, the second password, the hospital ID, and the hospital password as keys.

### BACKGROUND OF THE INVENTION

1. Field of the Invention

The present invention relates to a method for making commonly available information such as a clinical chart and the like about the medical treatment of an individual.

2. Description of the Related Art

Hitherto, there has been a trend towards storing on a database information about the medical care of an individual such as the clinical charts or the like held by each individual hospital inside that hospital. Alternatively, there has been a trend towards storing on a database information, such as the clinical charts or the like about the medical care of an individual, of a plurality of hospitals using a network or the like formed between the plurality of hospitals.

However, the following problems have occurred in the conventional storing on a database of the individual medical care information.

Namely, the problem has arisen that because each individual hospital has to manage its own database, the cost is extremely high.

Another problem has been that although the sharing of individual medical information via a database is being done by a plurality of hospitals, it has not been successful in reducing the costs borne by each individual hospital enough to make the number of hospitals participating in the sharing increase sufficiently. The result of this has been that because the number of participating hospital is small, the effect of making the database commonly available has not been felt.

Further, another problem has been that, because the making of individual medical information such as clinical charts available on a database is carried out by hospital staff, it is not possible or is difficult for a patient (i.e. a user) to view their own individual medical information such as a clinical chart.

### SUMMARY OF THE INVENTION

The present invention has been conceived in view of the above problems in the conventional technology. It is an aim of the present invention to provide a method for sharing information about the medical care of an individual in which: the costs borne by the hospital are reduced and an increase in the number of participating hospitals can be promoted; a user is able to view individual medical care information such as the clinical chart, the extent of the treatment, the treatment costs, what medicines have been prescribed and the like of the user him or herself or of another person under the care of the user (for example, a juvenile or a handicapped person); the hospital is able to prescribe treatment and medicines appropriate for each individual person after considering the treatment information for that person such as past clinical charts and the like; and the patient is able to receive such appropriate treatment and medicine prescriptions.

It is another aim of the present invention to provide a method of using the medical information of an individual such as a clinical chart or the like that is both helpful and capable of being expanded as a business. It is a further aim to provide as a result of the above a method for sharing information about the medical care of an individual that can achieve even greater reductions in cost and prove to have an excellent degree of usefulness.

In order to achieve the above aims, the first aspect of the present invention is a method for sharing information concerning medical treatment of an individual that uses a network system in which a plurality of hospital terminals, a plurality of user terminals, and a database terminal for managing a database of information concerning medical treatment of an individual are mutually connected via a communication network, wherein information concerning medical treatment of an individual is shared after a user has acquired space for storing information concerning medical treatment of an individual and has acquired means for placing restrictions on and removing restrictions from access to the storage space by third parties including hospitals.

A second password such as that described below is proposed as the means for placing restrictions on and removing restrictions from access to the storage space by third parties including hospitals described in the above first aspect of the present invention.

Namely, the second aspect of the present invention is a method for sharing information concerning medical treatment of an individual that uses a network system in which a plurality of hospital terminals, a plurality of user terminals, and a database terminal for managing a database of information concerning medical treatment of an individual are mutually connected via a communication network, wherein a hospital acquires a hospital ID and a hospital password, a user acquires a user ID, a user password, a second password, and space for storing information concerning medical treatment of an individual in a database (storage capacity where the individual medical treatment information can be stored in a database), and a hospital acquires individual medical treatment information from the database using the user ID, the second password, the hospital ID, and the hospital password as keys, and stores updated individual medical treatment information in the database using the user ID, the second password, the hospital ID, and the hospital password as keys.

The third aspect of the present invention is the method for sharing information concerning medical treatment of an individual according to the second aspect of the present invention, wherein the user views individual medical treatment information on the database using the user ID and the user password as keys.

The fourth aspect of the present invention is the method for sharing information concerning medical treatment of an individual according to the second aspect of the present invention, wherein a charge is levied on the hospital when the hospital acquires individual medical treatment information from the database.

The fifth aspect of the present invention is the method for sharing information concerning medical treatment of an individual according to the second aspect of the present invention, wherein a charge is levied on the hospital when the hospital saves updated individual medical treatment information in the database.

The sixth aspect of the present invention is the method for sharing information concerning medical treatment of an individual according to the third aspect of the present invention, wherein a charge is levied on the user when the user views individual medical treatment information.

The seventh aspect of the present invention is the method for sharing information concerning medical treatment of an individual according to the second aspect of the present invention, wherein the user password is altered using the user ID and the user password as keys.

The eighth aspect of the present invention is the method for sharing information concerning medical treatment of an individual according to the second aspect of the present invention, wherein the second password is altered using the user ID and the user password as keys.

The ninth aspect of the present invention is the method for sharing information concerning medical treatment of an individual according to the second aspect of the present invention, wherein, if updated individual medical treatment information is not saved in the database within a predetermined time after the hospital has acquired the individual medical treatment information from the database, notification is sent to the hospital requesting updated individual medical treatment information.

The tenth aspect of the present invention is the method for sharing information concerning medical treatment of an individual according to the second aspect of the present invention, wherein notification of the updating of the individual medical treatment information is sent to the user when updated individual medical treatment information is saved in the database.

The eleventh aspect of the present invention is the method for sharing information concerning medical treatment of an individual according to the second aspect of the present invention, wherein the user specifies a hospital and restricts access by the specified hospital to the space where the individual medical treatment information of the user is stored using the user ID and the user password as keys.

The twelfth aspect of the present invention is the method for sharing information concerning medical treatment of an individual according to the second aspect of the present invention, wherein, a cooperating company terminal that is used by a cooperating company that is in cooperation with whoever is managing the database is incorporated into the network system and, using this network system, the cooperating company acquires a cooperating company ID and cooperating company password and, after the user has given permission for the individual medical treatment information to be made available to the cooperating company using the user ID and user password as keys, the cooperating company acquires the individual medical treatment information of the user from the database using the cooperating company ID and cooperating company password as keys.

The thirteenth aspect of the present invention is the method for sharing information concerning medical treatment of an individual according to the twelfth aspect of the present invention, wherein a charge is levied on the cooperating company when the cooperating company acquires individual medical treatment information from the database.

The fourteenth aspect of the present invention is the method for sharing information concerning medical treatment of an individual according to the second aspect of the present invention, wherein treatment costs are included in the individual medical treatment information.

The fifteenth aspect of the present invention is the method for sharing information concerning medical treatment of an individual according to the fourteenth aspect of the present invention, wherein the user is issued with a treatment cost report calculated from treatment costs on the database using the user ID and user password as keys.

The sixteenth aspect of the present invention is the method for sharing information concerning medical treatment of an individual according to the second, eleventh, or twelfth aspects of the present invention, wherein the database terminal receives a request sent from the hospital terminal or from the cooperating company terminal for the individual medical treatment information of the user to be made available and transfers this to the user terminal of the user, and also receives approval from the user terminal regarding the request for the individual medical treatment information to be made available.

The present invention as it relates to a database that can be effectively used for implementing the above described method for sharing information concerning medical treatment of an individual is disclosed below.

Namely, the seventeenth aspect of the present invention is a database terminal for information concerning medical treatment of an individual comprising: a computer program for sending a user password and a second password to a user terminal; and a computer program that requests the second password when a person other than the user accesses the space where the individual medical treatment information is stored.

The result of this is that, in order for a person other than the user to access the space where the individual medical treatment information is stored, that person needs to know the second password. Because this second password is sent to the user terminal, the user is able to prevent any person other than the user from acquiring the individual medical treatment information of the user. If the user permits a person other than the user to acquire the individual medical treatment information of the user, the user can enable that person to acquire the individual medical treatment information by informing that person of the second password.

The eighteenth aspect of the present invention is a database terminal for information concerning medical treatment of an individual according to the seventeenth aspect, wherein there is further provided a computer program for requesting the user password when the second password is altered.

The result of this is that, because the user is able to alter the second password using the user password, it is possible to prevent a person other than the user from acquiring the individual medical treatment information of the user even after the second password has been made known to the person other than the user.

The nineteenth aspect of the present invention is a database terminal for information concerning medical treatment of an individual comprising: a computer program that counts a predetermined time from the point when individual medical treatment information is sent to a hospital terminal and determines whether or not updated individual medical treatment information has been received, and if a precondition of the predetermined time having passed and the updated individual medical treatment information not having been received is met, the computer program automatically sends a notification requesting an update of the individual medical treatment information to the hospital terminal.

The twentieth aspect of the present invention is a database terminal for information concerning medical treatment of an individual comprising: a computer program that determines whether or not updated individual medical treatment information has been received, and if a precondition of the updated individual medical treatment information having been received is met, the computer program automatically sends a notification requesting an update of the individual medical treatment information to the hospital terminal.

The twenty-first aspect of the present invention is a database terminal for information concerning medical treatment of an individual comprising: a computer program that follows a routine to a step in which set conditions concerning access restrictions on the space where the individual medical treatment information is stored are altered if a precondition of the user password having been requested and the requested user password having been received is met.

The twenty-second aspect of the present invention is a method for sharing information concerning medical treatment of an individual that uses a network system in which a plurality of hospital terminals, a plurality of user terminals, and a database terminal for managing a database of clinical charts of users who are patients are mutually connected via a communication network, said method comprising a procedure for registering from a hospital terminal, a procedure for registering from a user terminal, a procedure for acquiring a clinical chart from a hospital terminal, and a procedure for updating a clinical chart from a hospital terminal, wherein the procedure for registering from a hospital terminal comprises the following steps: a step (A1) in which a hospital terminal accesses a homepage for hospitals; a step (A2) in which the database terminal responds to this by sending registration procedure information for hospitals to the hospital terminal; a step (A3) in which the hospital terminal sends the data needed for registering in accordance with the registration procedure information for hospitals to the database terminal; a step (A4) in which the database terminal responds to this by sending a hospital ID, a temporary hospital password, and information on the hospital password altering procedure to the hospital terminal; a step (A5) in which, in accordance with the hospital password altering procedure information, the hospital terminal sends an altered hospital password together with the hospital ID and the hospital password to the database terminal; and a step (A6) in which the database terminal responds to this by determining the legitimacy of the hospital ID and the hospital password and sends a message approving the hospital password alteration to the hospital terminal, and wherein the procedure for registering from a user terminal comprises the following steps: a step (B1) in which the user terminal accesses the homepage for users; a step (B2) in which the database terminal responds to this by sending registration procedure information for users to the user terminal; a step (B3) in which the user terminal sends the data needed for registering in accordance with the registration procedure information for users to the database terminal; a step (B4) in which the database terminal responds to this by sending a user ID, a temporary user password, one or more than one temporary second passwords and user passwords, and information on the user password altering procedure to the user terminal, prepares a clinical chart for the user and stores it in the database; a step (B5) in which, in accordance with the user password and the second password altering procedure information, the user terminal sends the user ID, the temporary user password, an altered user password and the altered second password to the database terminal; and a step (B6) in which the database terminal determines the legitimacy of the user ID and the temporary user password and sends a message approving the user password and the second password alteration to the user terminal, and wherein the procedure for acquiring a clinical chart from a hospital terminal comprises the following steps: a step (C3) in which the hospital terminal sends the user ID and the second password to the database terminal; a step (C4) in which the database terminal responds to this by determining the legitimacy of the user ID and the second password and sends the information concerning the procedure for acquiring the clinical chart to the hospital terminal; a step (C5) in which, in accordance with the procedure for acquiring the clinical chart, the hospital terminal sends a signal with the hospital ID, the hospital password, and notice of the desire to acquire the clinical chart to the database terminal; a step (C6) in which the database terminal responds to this by determining the legitimacy of the hospital ID and the hospital password and sends the clinical chart of the user specified by the user ID to the hospital terminal; and a step (C7) linked to the above step in which the database terminal charges a fee for using the database to the hospital specified by the hospital ID, and wherein the procedure for updating a clinical chart from a hospital terminal comprises the following steps: a step (C10) in which the hospital ID sends the user ID and the second password to the database terminal; a step (C11) in which the database terminal responds to this by determining the legitimacy of the user ID and the second password and sends the first clinical chart saving procedure information to the hospital terminal; a step (C12) in which, in accordance with the first clinical chart saving procedure information, the hospital terminal sends a signal with the hospital ID, the hospital password, and notice of the desire to save the clinical chart to the database terminal; a step (C13) in which the database terminal responds to this by determining the legitimacy of the hospital ID and the hospital password and sends the second clinical chart saving procedure information to the hospital terminal; a step (C14) in which, in accordance with the second clinical chart saving procedure information, the hospital terminal sends the clinical chart to the database terminal; a step (C15) in which the database terminal responds to this by determining whether the received chart is the user chart specified by the user ID and saves this chart in the database; and a step (C16) linked to the above step in which the database terminal charges a fee for using the database to the hospital specified by the hospital ID.

In the above embodiment, a clinical chart is included among the information concerning the medical treatment of an individual. As the mode of use on the user side, in addition to when the patient him or herself is the user, it is also effective when the user is a person other than the patient who has care of the welfare of the patient such as a guardian or caregiver of a juvenile or a handicapped person.

### BRIEF DESCRIPTION OF THE DRAWINGS

FIG. 1 is a block diagram showing the structure used in the method for sharing the medical information of an individual according to the first embodiment of the present invention.

FIG. 2 is a flow chart showing the flow of the registration procedure of a hospital according to the first embodiment of the present invention.

FIG. 3 is a flow chart showing the flow of the registration procedure of a user according to the first embodiment of the present invention.

FIG. 4 is a flow chart showing the procedure when a hospital uses the chart of a user according to the first embodiment of the present invention.

FIG. 5 is a flow chart showing the procedure when a user views the user's own chart according to the first embodiment of the present invention.

FIG. 6 is a flow chart showing the procedure of the method for sharing the medical information of an individual according to the second embodiment of the present invention.

FIG. 7 is a flow chart showing the procedure of the method for sharing the medical information of an individual according to the third embodiment of the present invention.

FIG. 8 is a flow chart showing the procedure of the method for sharing the medical information of an individual according to the fourth embodiment of the present invention.

FIG. 9 is a block diagram showing the structure used in the method for sharing the medical information of an individual according to the fifth embodiment of the present invention.

FIG. 10 is a flow chart showing the procedure of the method for sharing the medical information of an individual according to the fifth embodiment of the present invention.

FIG. 11 is a flow chart showing the procedure of the method for sharing the medical information of an individual according to the sixth embodiment of the present invention.

FIG. 12 is a flow chart showing the procedure of the method for sharing the medical information of an individual according to the seventh embodiment of the present invention.

FIG. 13 is a schematic diagram of a home page for describing a procedure using the home page in an embodiment of the present invention.

FIG. 14 is another schematic diagram of a home page for describing a procedure using the home page in an embodiment of the present invention.

FIG. 15 is another schematic diagram of a home page for describing a procedure using the home page in an embodiment of the present invention.

FIG. 16 is another schematic diagram of a home page for describing a procedure using the home page in an embodiment of the present invention.

FIG. 17 is another schematic diagram of a home page for describing a procedure using the home page in an embodiment of the present invention.

FIG. 18 is another schematic diagram of a home page for describing a procedure using the home page in an embodiment of the present invention.

### DESCRIPTION OF THE PREFERRED EMBODIMENTS

A description will now be given of the method for sharing information about the medical care of an individual according to an embodiment of the present invention with reference made to the drawings. It should be noted that the description below is of an embodiment of the present invention and in no way limits the scope of the present invention. In the embodiments below, a clinical chart is used as an example of an individual's medical care information, however, information about the medical care of an individual other than a clinical chart that it may be beneficial to load on a database may naturally be used. In addition, in the embodiments below, the aforementioned second password is described as the password of the used hospital (or the used hospital password).

First Embodiment

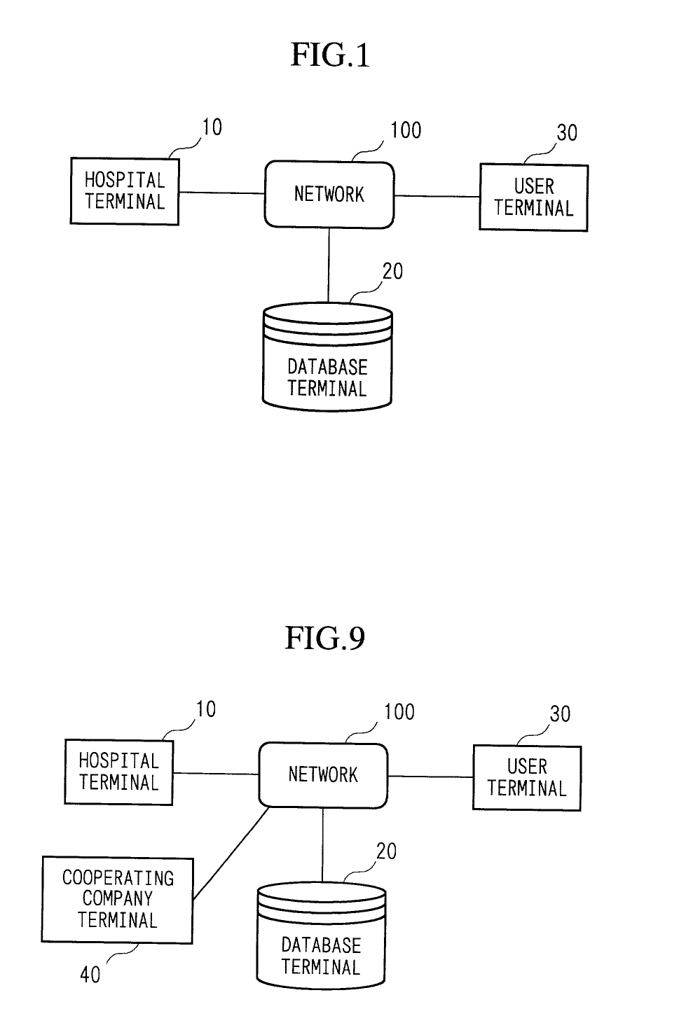

Firstly, a description will be given of the structure of the method for sharing information about the medical care of an individual according to the first embodiment of the present invention with reference made to FIG. 1. FIG. 1 is a block diagram showing the structure used in the method for sharing the medical information of an individual according to the first embodiment of the present invention.

As is shown in FIG. 1, the method for sharing information about the medical care of an individual according to the first embodiment of the present invention uses a plurality of hospital terminals 10, a database terminal 20, a plurality of user terminals 30, and a communication network 100 such as the internet that connects these all together.

The hospital terminal 10 is information processing device capable of being used at the hospital such as a personal computer, a workstation server, or the like.

The database 20 is an information processing device such as a workstation server, a normal computer, or the like and is provided with the function of storing and managing data such as the information and charts of a user, and a certification function of verifying the certification of the user or of a hospital or the like that has obtained permission from the user using fingerprints and passwords and the like. The database terminal 20 also provides a sharing service home page for hospitals and for users where separate or combined charts can be reviewed via the Internet 100. The homepage and the services below that use the database terminal 20 are provided by database sharing business management companies.

The user terminal 30 is an information processing device capable of being used by a user such as a personal computer or the like.

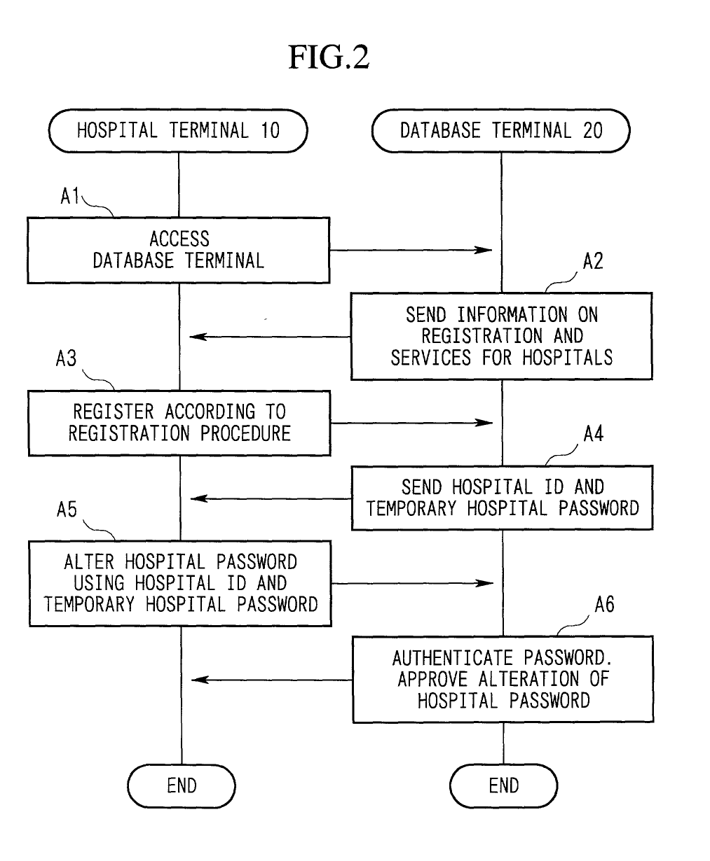

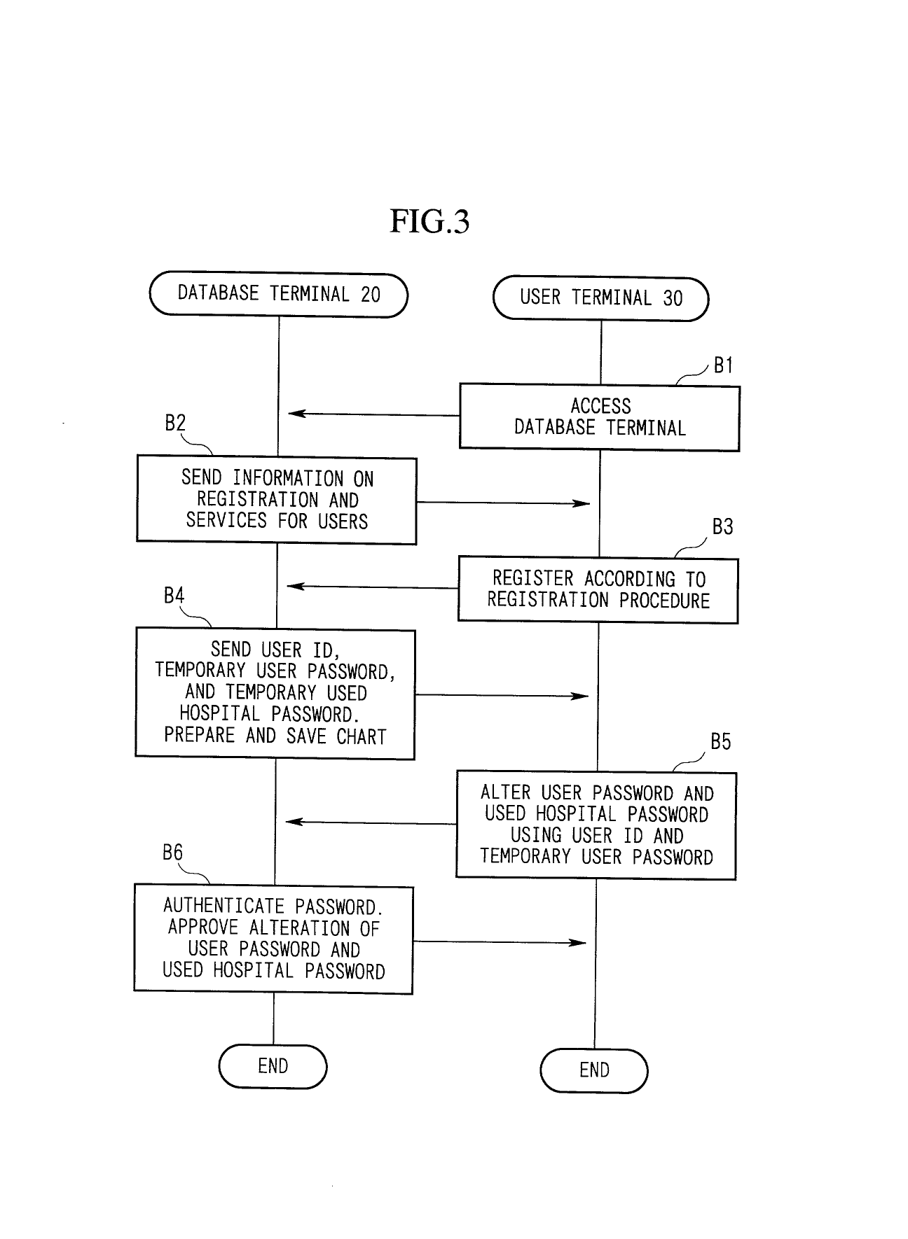

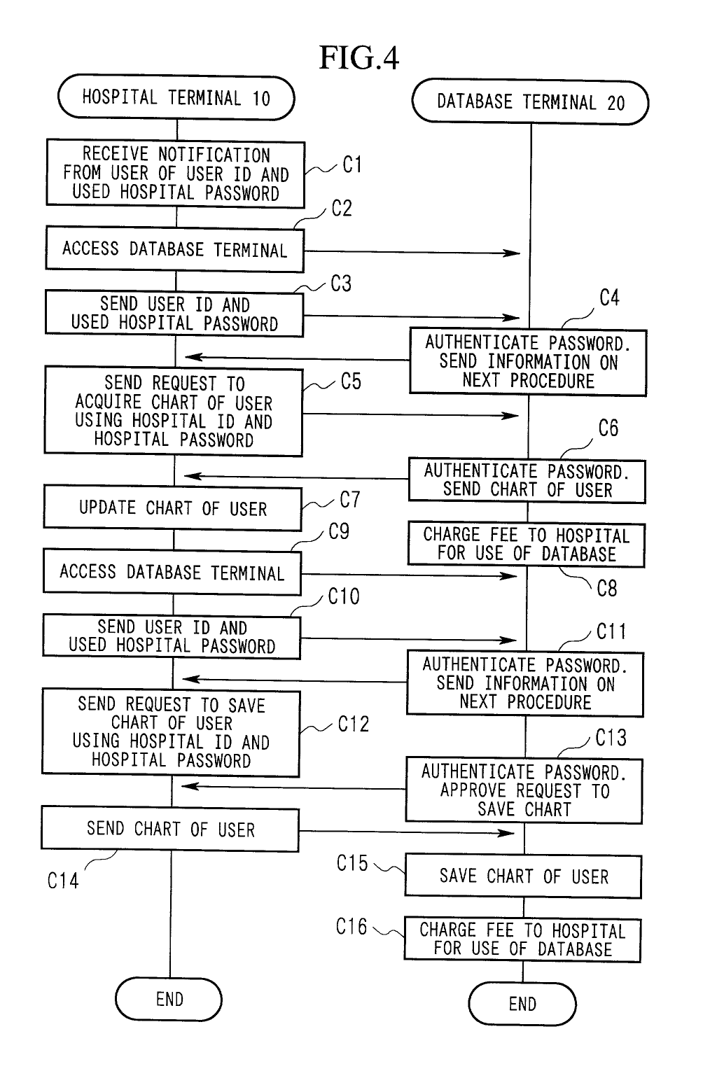

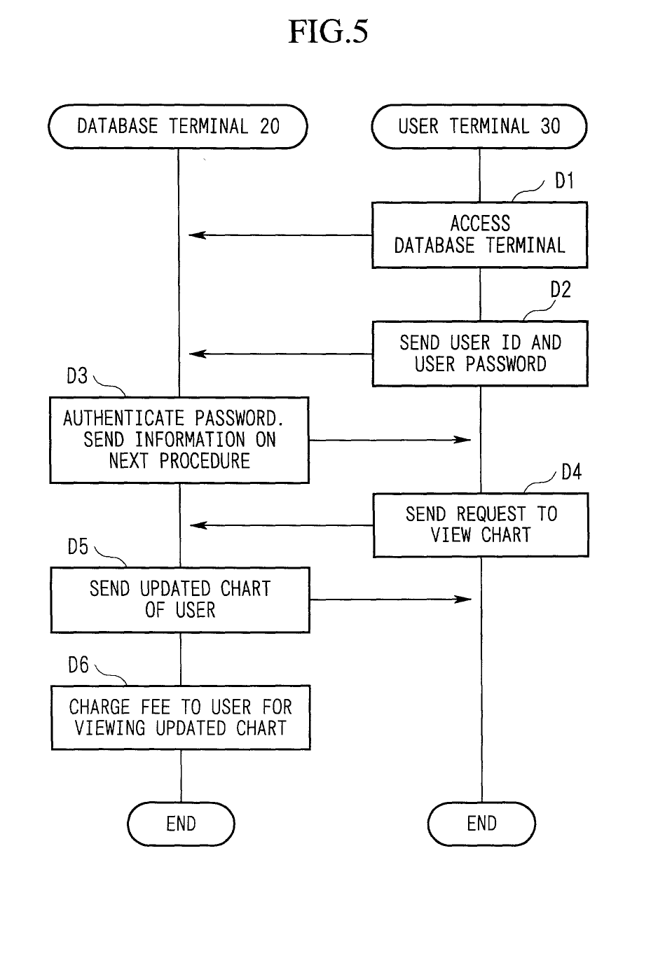

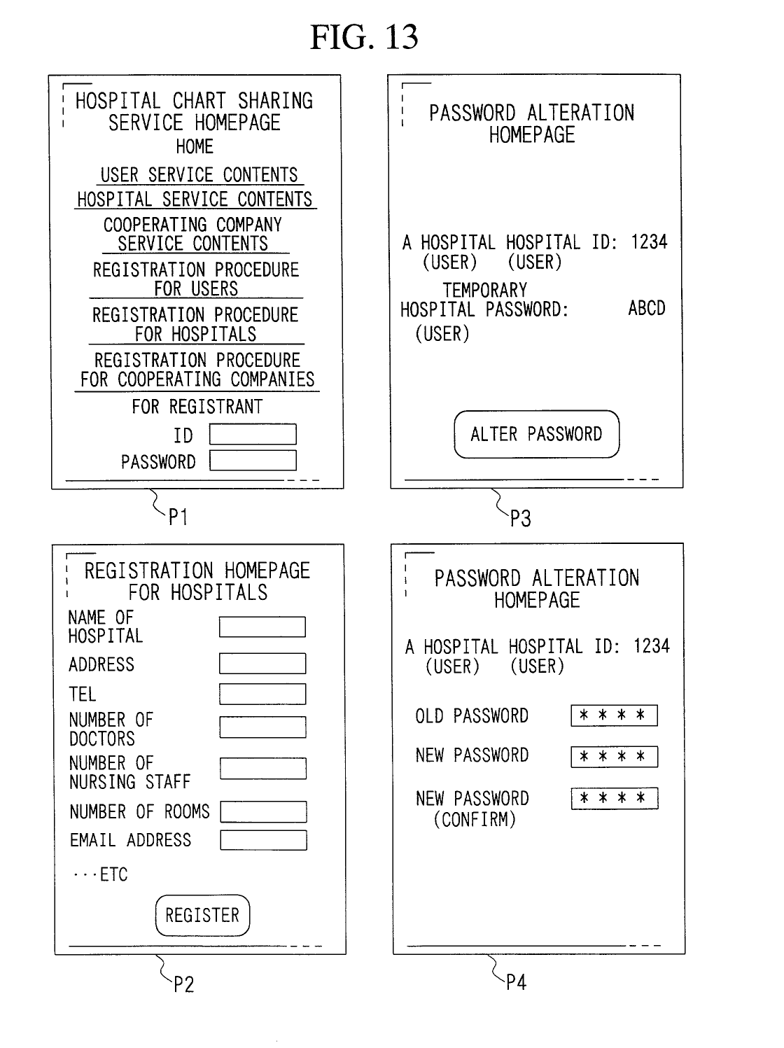

Next, a description will be given in detail of procedure of the individual treatment information sharing method according to the first embodiment, with reference being made to FIGS. 1 to 5 and 13 to 15. Note that, in the description given below, the network 100 is understood to be the Internet. FIG. 2 is a flow chart showing the registration procedure of a hospital according to the first embodiment of the present invention. FIG. 3 is a flow chart showing the registration procedure of a user according to the first embodiment of the present invention. FIG. 4 is a flow chart showing the procedure when a hospital uses the chart of a user according to the first embodiment of the present invention. FIG. 5 is a flow chart showing the procedure when a user views the user's own chart according to the first embodiment of the present invention. FIGS. 13 to 15 show an example of a homepage for chart sharing.

Firstly, the hospital registration procedure will be described with reference to FIGS. 1, 2, and 13. As is shown in FIG. 2, the hospital that wishes to register (referred to here as Hospital A) uses the hospital terminal 10 to access the chart sharing service homepage via the Internet 100 (step A1).

In response to step A1, the database terminal 20 sends registration procedure information and chart database sharing service information for the hospital to the hospital terminal 10 (step A2). This causes the registration procedure information and chart database sharing service information for the hospital to be displayed on a display unit by the hospital terminal 10 and Hospital A registers in accordance with the displayed registration procedure information (step A3).

In response to step A3, the database terminal 20 transmits the hospital ID, a temporary password for the hospital, as well as information on the procedure to alter the password for the hospital to the hospital terminal 10 (step A4). In response, the transmitted contents are displayed on the display unit of the hospital terminal 10.

Next, in accordance with the hospital password alteration procedure information displayed on the display unit of the hospital terminal 10, Hospital A sends the altered hospital password together with the temporary hospital password and the hospital ID sent in step A4 to the database terminal 20 (step A5).

In response to this, the database terminal 20 authenticates Hospital A using the hospital ID and the temporary hospital password. If the hospital ID and the temporary hospital password are correct, the database terminal 20 sends a message that the altering of the hospital password is approved to the hospital terminal 10 (step A6).

Hospital A performs the chart database sharing registration for hospitals as described above. This database sharing registration for hospitals is performed via a homepage such as that shown in FIG. 13. Namely, Hospital A that has accessed the Chart Sharing Service Homepage P1 clicks on “Hospital Registration Procedure”. In response, the screen jumps to the Hospital Registration Homepage P2. On this page, Hospital A inputs the hospital name, address, telephone number, number of doctors, number of nurses, number of hospital rooms, email address, etc. and clicks the “Register” button. This causes the Password Alteration Homepage P3 to open up and the hospital ID and temporary hospital password allocated to Hospital A are displayed on the page. Hospital A makes a record of this and clicks the “Alter Password” button. This causes the screen to jump to the Password Alteration Homepage P4. On this page, Hospital A carries out the password alteration input. As a result, a password alteration approval screen (not shown) that includes a message such as “Password Alteration Approved” is displayed on the hospital terminal 10 and the registration procedure is completed.

Next, the user registration procedure will be described with reference to FIGS. 1, 3, 13, and 14.

As is shown in FIG. 3, the user who wishes to register (referred to here as User B) uses the user terminal 30 to access the chart database homepage for users via the Internet 100 (step B1).

In response to step B1, the database terminal 20 sends registration procedure information and chart database sharing service information for the user to the user terminal 30 (step B2). In response, the registration procedure information and chart database sharing service information for the user is displayed on a display unit of the user terminal 30 and User B registers in accordance with the registration procedure information (B3).

In response to step B3, the database terminal 20 transmits the user ID, a temporary password for the user, one or two or more temporary passwords for the hospitals used (i.e. the second password), as well as information on the procedure to alter the user password and the used hospital password to the user terminal 30. Moreover, a user clinical chart is created and stored in the database (step B4). In response, the transmitted contents are displayed on the display unit of the user terminal 30.

Next, in accordance with the user password and used hospital password alteration procedure information displayed on the display unit of the user terminal 30, User B sends the altered user password and the altered password for the hospital used together with the temporary user password and the user ID already sent to the database terminal 20 (step B5).

Next, the database terminal 20 authenticates User B using the user ID and the temporary user password. If the user ID and the temporary user password are correct, the database terminal 20 sends a message that the altering of the user password and the used hospital password are approved to the user terminal 30 (step B6).

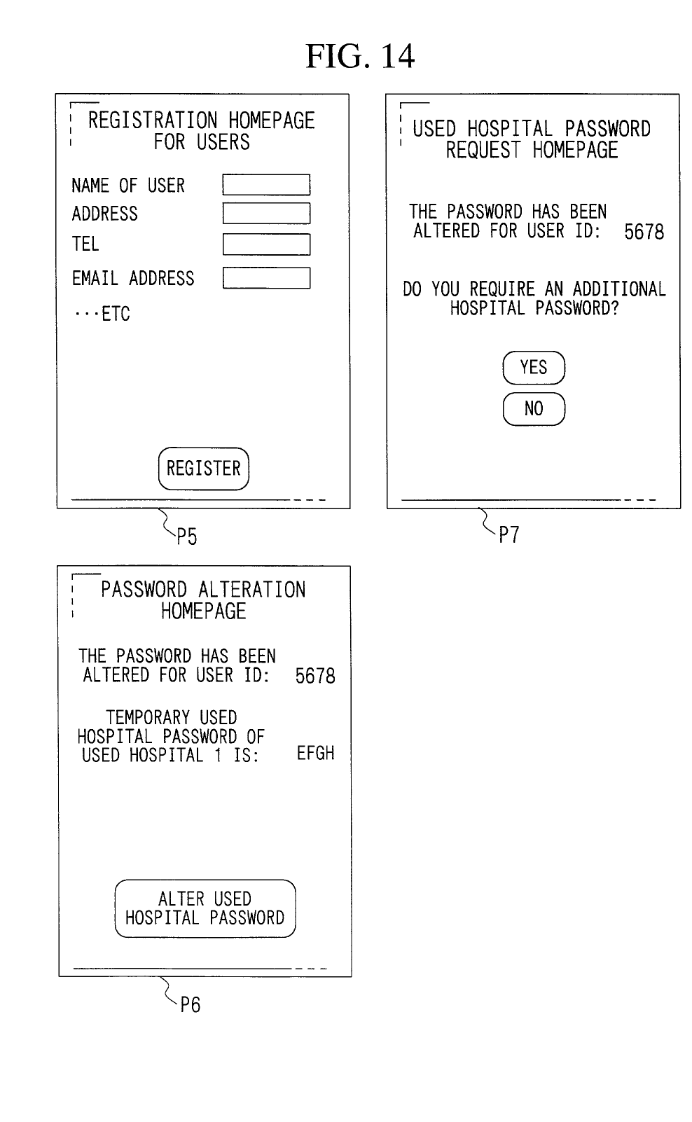

User B performs the chart database sharing registration for the user as described above. This database sharing registration for the user is performed via a homepage such as those shown in FIG. 13 and FIG. 14. Namely, User B who has accessed the chart sharing service homepage P1 clicks on “User Registration Procedure”. In response, the screen jumps to the User Registration Homepage P5. On this page, User B inputs his or her name (i.e. the user name), address, telephone number, email address, etc. and clicks the “Register” button. This causes the Password Alteration Homepage P3 to open up and the user ID and temporary user password allocated to User B are displayed on the page. User B makes a record of this and clicks the “Alter Password” button. This causes the screen to jump to the Password Alteration Homepage P4. On this page, User B carries out the password alteration input and obtains a new password. Next, the screen changes to the Password Alteration Homepage P6 and a message saying that the alteration of the user password is completed as well as the temporary password of the hospital used are displayed. User B makes a record of this and clicks the “Alter Used Hospital Password” button. This causes the screen to jump to the Password Alteration Homepage P4. On this page, User B carries out the used hospital password alteration input and obtains a new password for the hospital used. Next, the screen changes to the Used Hospital Password Request Homepage P7, and a message saying that the alteration of the used hospital password is completed is displayed together with a message asking whether there is an additional request for a used hospital password. User B clicks YES if he or she requires an additional used hospital password and clicks NO if an additional used hospital password is not required. If YES is clicked, then the procedures of Pages P6, P4, and P7 are repeated in that order. If NO is clicked, User B has completed database sharing registration.

Next, a description will be given of the procedure when the hospital wishes to use the clinical chart of a user with reference made to FIGS. 1 and 4.

As is shown in FIG. 4, a hospital that is registered to share the chart database for hospital use (referred to below as Hospital C) receives a request to share the database of a patient who is also a registered user (referred to below as User D) of the user chart shared database from User D. At the same time, Hospital C receives notification from User D of the user ID and the password of the hospital used.

Next, Hospital C uses the hospital terminal 10 to access the database terminal 20 via the Internet 100 (step C2). Next, the user ID of User D and the password of the hospital used (or the hospital ID and hospital password) are sent to the database terminal 20 (step C3).

In response to this, the database terminal 20 authenticates User D using the user ID and the password of the hospital used. If the user ID and the used hospital password are correct, the database terminal 20 sends information on the next procedure to the hospital terminal 10 (step C4). When this is done, the contents of this transmission are displayed on the display unit of the hospital terminal 10.

Next, in accordance with the information concerning the next procedure displayed on the display unit of the hospital terminal 10, Hospital C transmits to the database terminal 20 the fact that User D has made a request to acquire the chart, together with the hospital ID and hospital password (if the hospital ID and hospital password were sent earlier in step C3, then the used hospital password and the user ID of User D are sent) (step C5).

In response to this, the database terminal 20 authenticates Hospital C using the hospital ID and the hospital password. If the hospital ID and the hospital password are correct, the database terminal 20 sends the chart of User D to the hospital terminal 10 (step C6). At this time, the database terminal 20 charges Hospital C the fee for using the database (step C7).

Thereafter, Hospital C records and updates the obtained chart treatment stage, the treatment cost, the condition of the medication prescription, and the like of User D (step C8).

Hospital C accesses the database terminal 20 each time the chart of User D is updated and sends the user ID and the password of the hospital being used to the database terminal 20 (step C10).

In response, the database terminal 20 authenticates User D using the user ID and the password of the hospital being used. If the user ID and the used hospital password are correct, the database terminal 20 sends information about the next procedure to the hospital terminal 10 (step C11). When this is done, the contents of this transmission are displayed on the display unit of the hospital terminal 10.

Next, in accordance with the information concerning the next procedure displayed on the display unit of the hospital terminal 10, Hospital C transmits to the database terminal 20 the fact that User D has made a request to save the chart, together with the hospital ID and hospital password (step C12).

In response to this, the database terminal 20 authenticates Hospital C using the hospital ID and the hospital password. If the hospital ID and the hospital password are correct, the database terminal 20 sends information about the chart saving procedure to the hospital terminal 10 (step C13). When this is done, the contents of this transmission are displayed on the display unit of the hospital terminal 10.

Next, in accordance with the information concerning the chart saving procedure displayed on the display unit of the hospital terminal 10, Hospital C sends the chart of User D to the database terminal 20 (step C14).

In response to this, the database terminal 20 saves the chart of User D in the database (step C15) and charges Hospital C the fee for using the database (step C16).

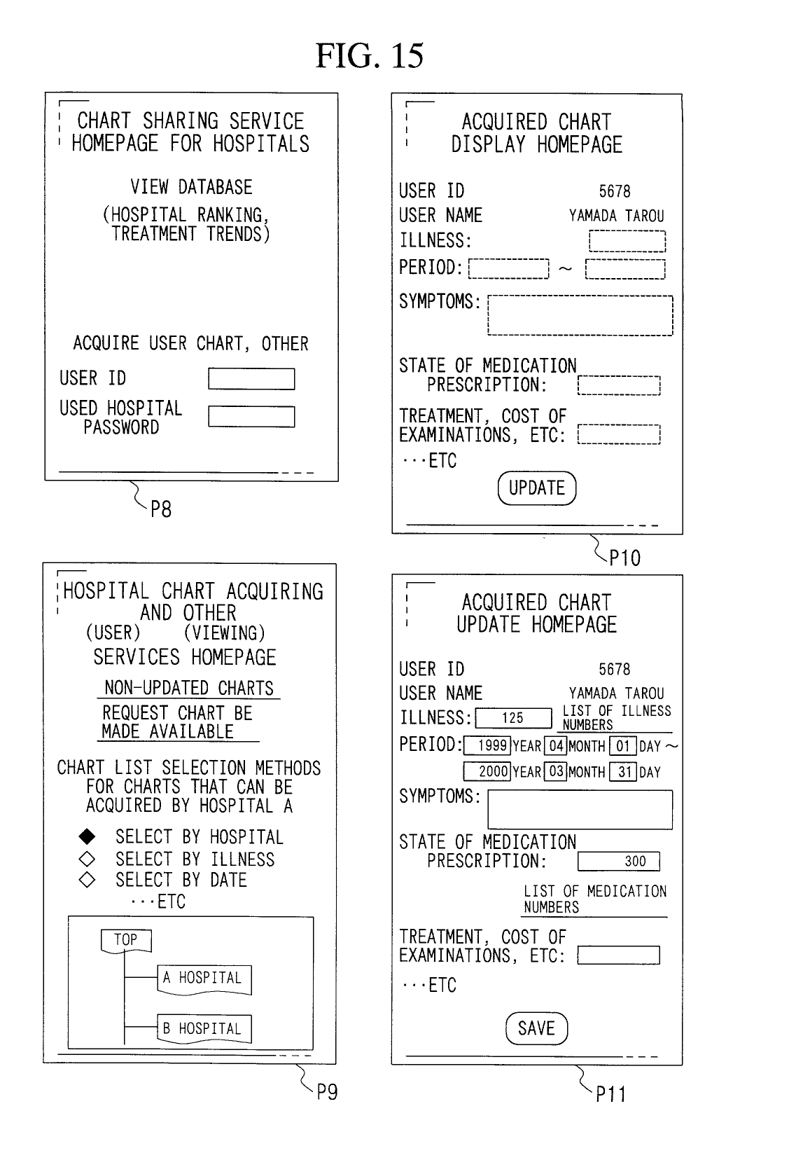

In this way, Hospital C acquires and updates the chart of User D from the database specified by the user and saves the chart in the database. This acquiring and saving of the chart may be performed using, for example, the homepages shown in FIGS. 13 and 15. Namely, when it accesses the chart sharing service homepage P1, Hospital C clicks on “Hospital Service Contents”. If the hospital ID and hospital password have not been input, a request is made asking for their input. Hospital C then makes the inputs as requested. This causes the screen to jump to the Chart Sharing Service Homepage for Hospitals P8. On this page, Hospital C inputs the password of the hospital being used and the user ID of User D. In response, the screen jumps to Hospital Chart Obtaining and Other Services Homepage P9. On this page, the chart database allocated to User D is displayed. This database may have a directory tree structure, for example, as is shown in FIG. 15, and is displayed as a structure in which it is possible to select various classifications on the display such as “select by hospital”, “select by illness”, select by date”, etc. Hospital C opens a folder and then opens the desired chart file by double clicking it or the like. As a result, for example, the page P9 is divided and the contents of the selected chart file are displayed on the right hand three fourths of the page. This may be displayed, for example, in a structure such as that shown in the Chart Display Homepage P10. Hospital C repeats the above operation to view and use the charts. As is shown in the Chart Display Homepage P10, previous illnesses and medicine prescriptions can be confirmed, enabling Hospital C to carry out appropriate measures for the patient.

When Hospital C has carried out measures to update the diagnosis, medicine prescription, treatment, and the like for the patient, it again accesses the Chart Display Homepage P10. In order to access the Chart Display Homepage P10, the accessing party only needs to click the “non-updated chart” legend on the Hospital Chart Obtaining and Other Services Homepage P9, as only charts that have not been updated since they were obtained by Hospital C are displayed in the display window of the directory tree structure when this legend is clicked. Next, the “Update” button on the Chart Display Homepage P10 is clicked. When this is done, the screen jumps to the Obtained Chart Updating Homepage P11. On this page, Hospital C inputs the illness name and number, the medication number, the condition of the illness, the cost of treatment and the cost of the examination, etc. This input of the illness name and number and medication number can be changed by clicking on “List of Illness Name and Numbers” and “List of Medication Numbers” on the Obtained Chart Update Homepage P11 so as to display on the screen a list (not illustrated) of medication numbers and illness names and numbers and then the illnesses and medications are selected by clicking on the list. Hospital C finishes inputting all the updated information and completes the updating procedure by clicking the Save button. This causes the updated contents to be saved on the chart database.

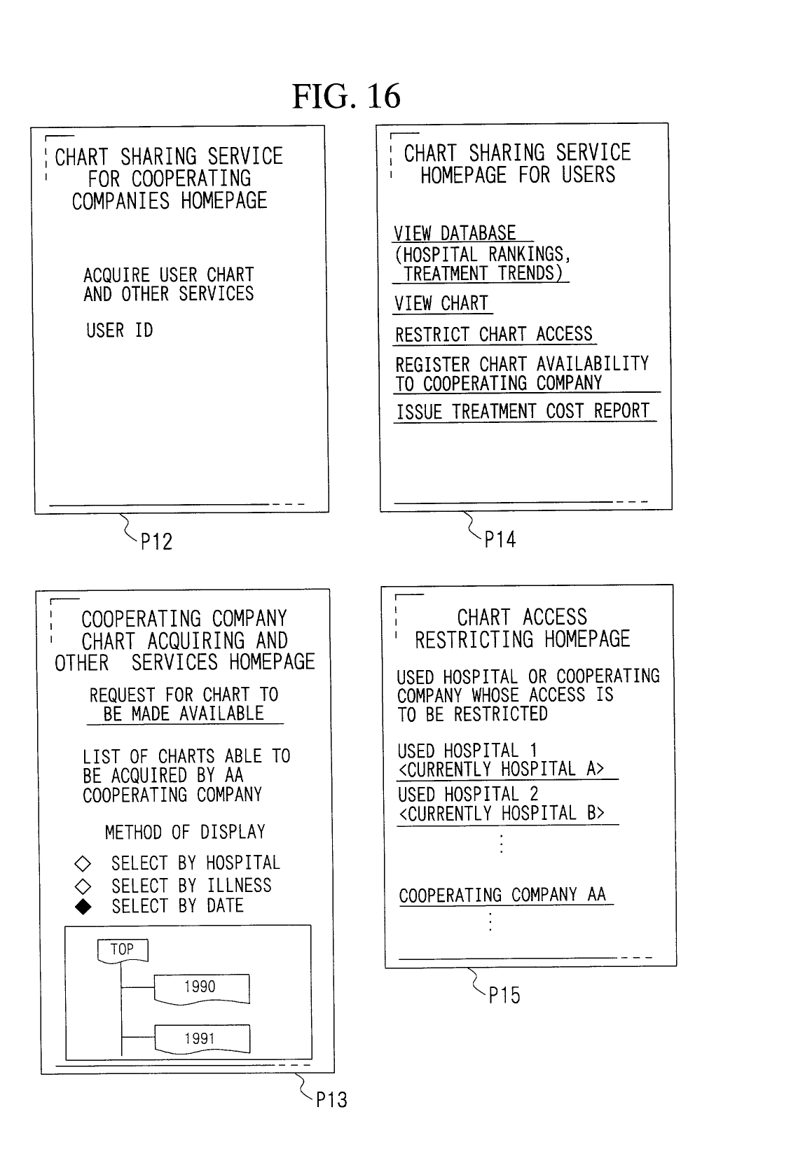

A description will be given next of procedure followed when a user views his or her own chart or the chart of another person under the care of the user (i.e. an underage or handicapped person) that is stored in the database, with reference to FIGS. 1, 5, 13, 15, and 16.

As is shown in FIG. 5, a user who has completed the registration procedure (this user will be referred to below as User E) uses the user terminal 30 to access the database terminal 20 via the Internet 100 (step D1).

Next, the User E sends his or her user ID and user password to the database terminal 20 (step D2). The database terminal 20 then authenticates User E by the user ID and the user password. If the user ID and the user password are correct, the database terminal 20 sends information about the next procedure to the user terminal 30 (step D3). This causes the contents of the transmission to be displayed on the screen of the user terminal 30.

Next, in accordance with the information about the next procedure displayed on the screen of the user terminal 30, User E informs the database terminal 20 about the fact that User E wishes to view a chart (step D4).

In response to this, the database terminal 20 sends the latest chart belonging to User E to the user terminal 30 (step D5). At this time, the database terminal 20 charges the user for the cost of viewing the chart (step D6).

The user thus views his or her own chart or the chart of another person under the care of the user (i.e. an underage or handicapped person) that is stored in the database. This viewing of the chart by the user is a procedure performed via a homepage such as that shown in FIGS. 13, 15, and 16. Namely, User E who has accessed the Chart Sharing Service Homepage P1 clicks on “User Service Contents”. If the user ID and user password have not been input, a request is made for these to be input and User E therefore make the inputs as requested. This causes the screen to jump to the Chart Sharing Service Homepage for Users P14. On this page, User E clicks on “View Chart” from the menu. This causes the screen to jump to the User Chart Viewing Service Homepage P9. On this page, the chart database allocated to User E is displayed. This database may have a directory tree structure, for example, as is shown in the drawings, and is displayed as a structure in which it is possible to select various classifications on the display such as “select by hospital”, “select by illness”, select by date”, etc. User E opens a folder and then opens the desired chart file by double clicking it or the like. As a result, for example, the page P9 is divided and the contents of the selected chart file are displayed on the right hand three fourths of the page. This may be displayed, for example, in a structure such as that shown in the Chart Display Homepage P10 (except for the Update button).

As has been described above, according to the present embodiment, via a network, a user is able to view a clinical chart, and confirm chart information such as the extent of the treatment, the treatment costs, what medication has been prescribed and the like and a hospital is able to prescribe treatment and medication appropriate for a user (i.e. a patient) after obtaining previous charts of the user.

Second Embodiment

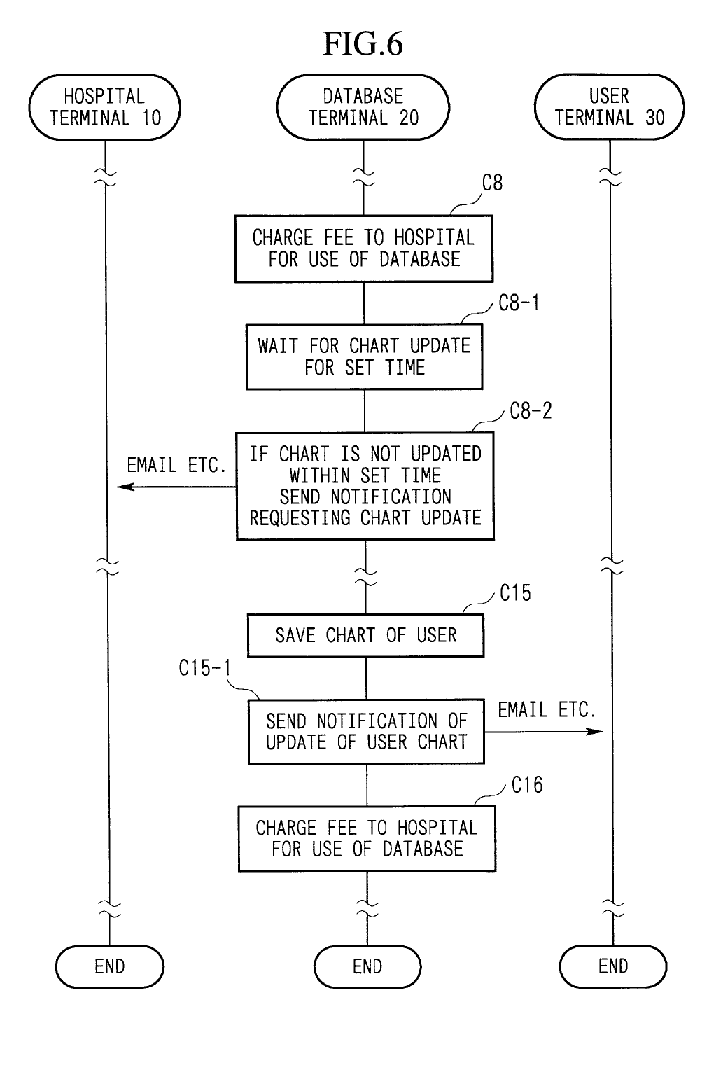

A description will be given next of the structure of the method for sharing information about the medical care of an individual according to the second embodiment of the present invention with reference made to FIGS. 1 and 6. FIG. 6 is a flow chart showing the procedure of the method for sharing information about the medical care of an individual according to the second embodiment of the present invention.

The second embodiment has substantially the same network structure and procedure as the above described first embodiment. However, it is different in that when the hospital updates a user's chart and using the hospital terminal 10 saves the user's chart in the database terminal 20 via the Internet 100, the database 20 responds by sending notification of the chart update to the user of the saved chart by email or the like. In addition, the second embodiment differs in that, if the hospital obtains the chart of a user from the database terminal 20 and does not save the updated chart in the database terminal 20 after a set time has passed, the database terminal 20 sends a chart update request notification to the hospital by email or the like.

The procedure of the method for sharing information about the medical care of an individual according to the second embodiment will now be described.

Firstly, in the same way as in the first embodiment, the database terminal 20 performs the procedures (i.e. from step A1 to step C8) as far as charging the hospital (referred to below as Hospital G) that has obtained the chart of a user (referred to below as User F) from the database.

Next, as is shown in FIG. 6, the database terminal 20 operates the chart update period time counter for a set time for Hospital G that has obtained the chart of User F (step C8-1).

If Hospital G does not update the chart of User F within the set time, the database terminal 20 sends a chart update request notification via email or the like to Hospital G that has acquired the chart of User F (step C8-2).

When it receives this chart update request notification, Hospital G accesses the database terminal 20 and saves the updated chart of User F. Namely, the procedures from step C9 to step C15 are performed in the same way as in the first embodiment.

In response, as is shown in FIG. 6, the database terminal 20 sends a chart update notification by email or the like to User F whose chart has been saved (step C15-1), and charges Hospital G the fee for using the database (step C16).

Thereafter, if the user who receives the chart update notification views his or her own chart, the procedures from step D1 to step D6 are performed in the same way as in the first embodiment.

As described above, according to this embodiment, the hospital is able to avoid neglecting to update the chart of a user being treated by the hospital and the user is able to immediately confirm that the chart has been updated.

Third Embodiment

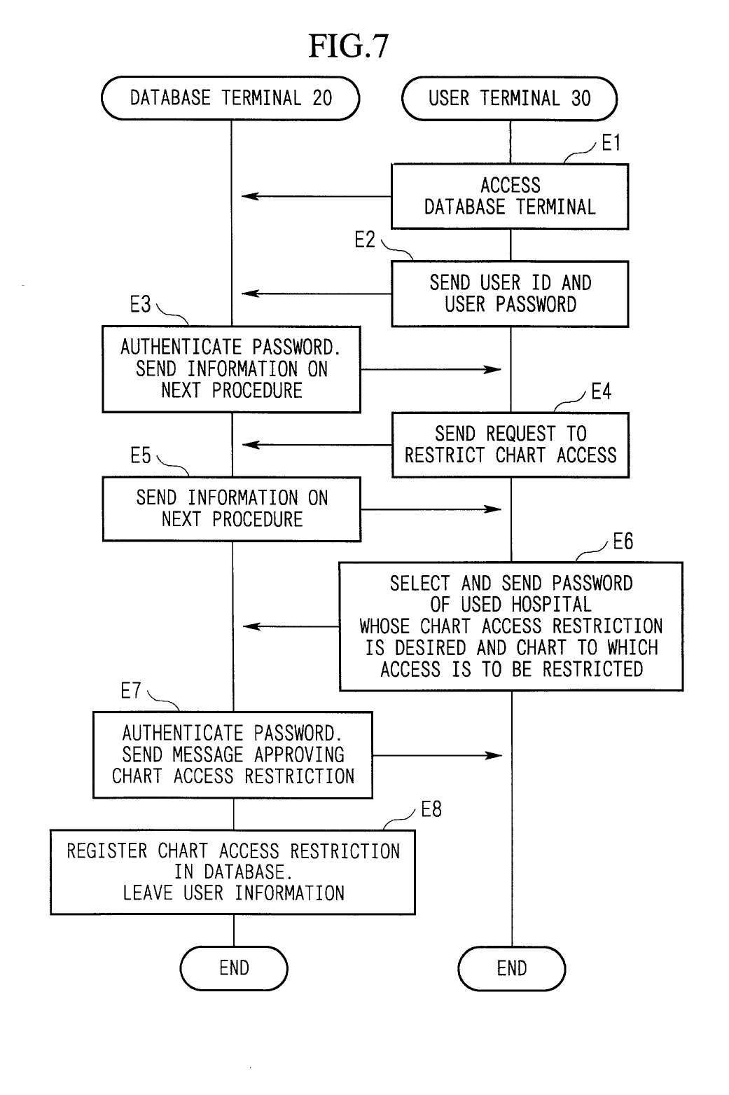

A description will be given next of the structure of the method for sharing information about the medical care of an individual according to the third embodiment of the present invention with reference made to FIGS. 1, 7, 13, and 16. FIG. 7 is a flow chart showing the procedure of the method for sharing information about the medical care of an individual according to the third embodiment of the present invention.

The third embodiment has substantially the same network structure and procedure as the above described first embodiment. However, it is different from the first embodiment in that it is possible to set restrictions on the access of a user's chart for the respective passwords when a user is sent passwords of one or two or more hospitals used by the user from the database terminal.

The procedure of the method for sharing information about the medical care of an individual according to the third embodiment will now be described.

As is shown in FIG. 7, a user who has completed the registration procedure (this user will be referred to below as User H) uses the user terminal 30 to access the database terminal 20 via the Internet 100 (step E1).

Next, the User H sends his or her user ID and user password to the database terminal 20 (step E2).

The database terminal 20 then authenticates User H by the user ID and the user password. If the user ID and the user password are correct, the database terminal 20 sends information about the next procedure to the user terminal 30 (step E3). This causes the contents of the transmission to be displayed on the screen of the user terminal 30.

Next, in accordance with the information about the next procedure displayed on the screen of the user terminal 30, User H informs the database terminal 20 about the fact that User E wishes to restrict access to a chart (step E4). In response to this, the database terminal 20 sends information about the next procedure to the user terminal 30 (step E5). This causes the contents of the transmission to be displayed on the screen of the user terminal 30.

Next, in accordance with the information about the next procedure displayed on the screen of the user terminal 30, User H selects the used hospital password of the hospital (referred to below as Hospital I) whose chart access the user wishes to restrict as well as the chart to which the user wishes to restrict access and sends these to the database terminal 20 (step E6).

In response to this, the database terminal 20 authenticates User H using the password of the hospital being used. If the used hospital password is correct, the database terminal 20 sends a message approving the restricting of the chart access to the user terminal 30 (step E7). At the same time as this, the chart access restriction is registered in the password of the hospital being used sent from the user terminal 30 and this registration is added to the user's record (step E8). Previous access restrictions made by the user are stored in the user record and overwriting of these is not possible. A third party (such as a hospital or the like) may obtain the user's record and use it to verify the period and conditions of the access restrictions.

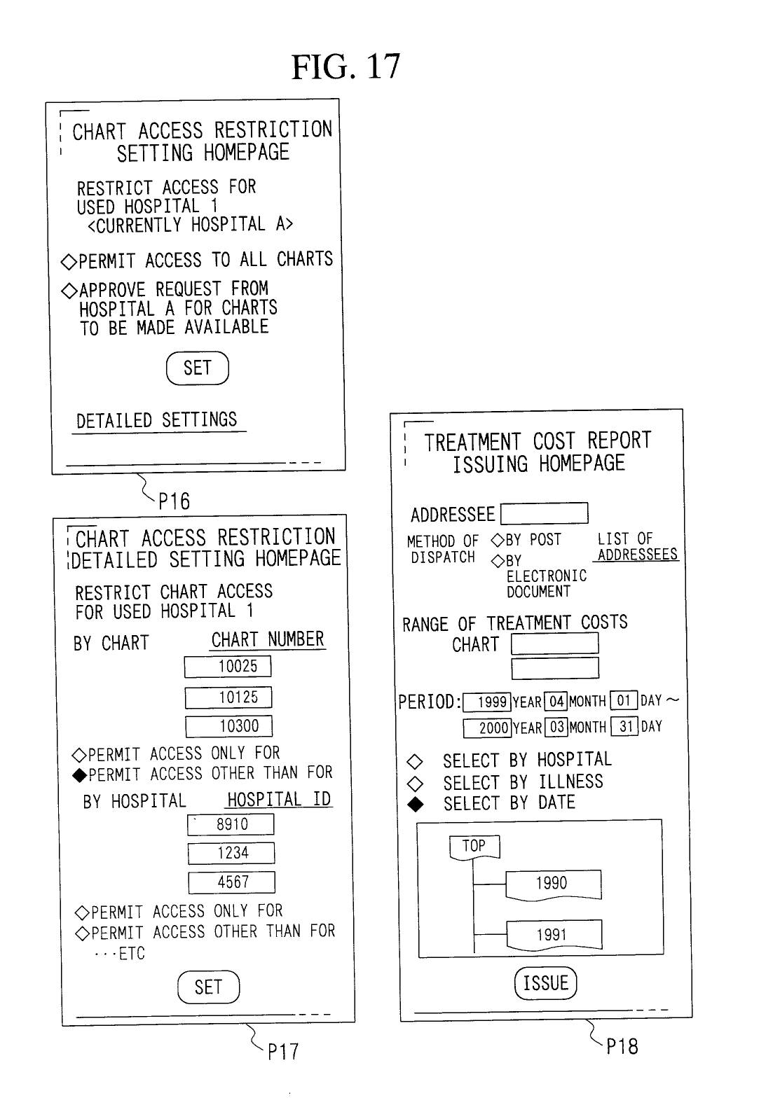

As has been described above, according to the present embodiment, because it is possible for User H to restrict chart access by hospital I, for example, Hospital I can be prevented from acquiring the chart of User H if this chart is not necessary when Hospital I is treating User H. Accordingly, the privacy of User H can be protected. The procedure for the setting of this access restriction can be followed on homepages such as those shown in FIGS. 13, 16, and 17. Namely, User H who has accessed the Chart Sharing Service Homepage P1 clicks on “User Service Contents”. If the user ID and user password have not been input, a request is made for these to be input and User H therefore make the inputs as requested. This causes the screen to jump to the Chart Sharing Service Homepage for Users P14. On this page, User H clicks on “Restrict Chart Access” from the menu. This causes the screen to jump to the Chart Access Restricting Homepage P15. On this page are displayed hospitals 1, 2, . . . etc that are used by User H and for which a used hospital password has been set as well as the names of several cooperating companies. For example, User H clicks on “Used Hospital 1”. This causes the Chart Access Restriction Setting Homepage P16 to open up. If User H wishes to restrict access to all of the charts of User H in used hospital 1 without exception, then User H simply clicks on the “Set” button on page P11. As a result, access to all of the charts of User H in used hospital 1 is restricted and no other person apart from User H is able to access the charts. If, however, User H wishes to set more detailed access restriction conditions, User H clicks on “Detailed Settings”. This causes the screen to jump to the Chart Access Restriction Detailed Setting Homepage P17. On this page, User H inputs conditions for restricting access by chart or by hospital and clicks the “Set” button. As a result, access restriction to charts in used hospital 1 under the input conditions (i.e. access restrictions to input charts (or to charts other than the input charts) or access restrictions to input hospitals (or to hospitals other than the input hospitals)) is begun. The method of inputting the input conditions may be a direct method in which the chart numbers and hospital IDs are directly input, or a list method in which a “List” button is clicked so as to display a list (not illustrated) and the relevant entries on the list then clicked, a selection method in which selections are made on a directory tree structure such as that shown in the homepage P9, or any other suitable method.

Fourth Embodiment

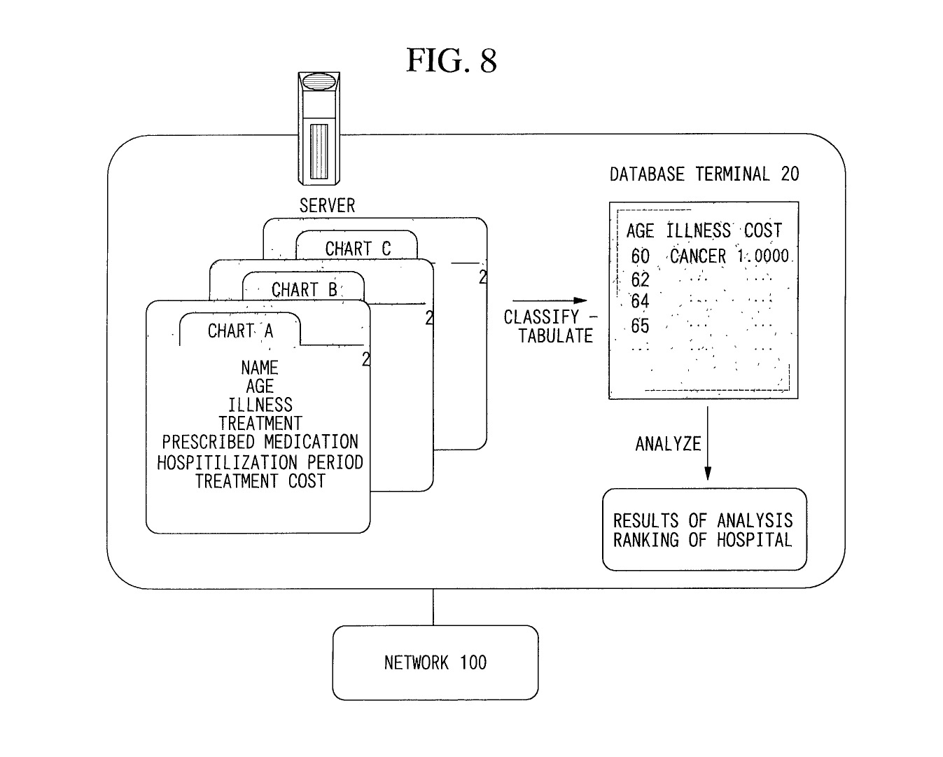

A description will be given next of the method for sharing information about the medical care of an individual according to the fourth embodiment of the present invention with reference made to FIGS. 1 and 8. FIG. 8 is a flow chart showing the procedure of the method for sharing information about the medical care of an individual according to the fourth embodiment of the present invention.

The fourth embodiment has substantially the same network structure and procedure as the above described first embodiment. However, it is different from the first embodiment in that the database sharing business management company that manages the database terminal 20 tabulates and analyzes the data of the charts of all registered users or the data of the charts of specific users after having obtained the permission of those users and then makes any processed information of value available to the user.

The procedure of the method for sharing information about the medical care of an individual according to the fourth embodiment will now be described.

As is shown in FIG. 8, the cards of all the users saved on the database terminal 20 or the cards of users from whom permission has been received are classified and tabulated by the database sharing business management company using a normal computer or the like. The database sharing business management company carries out the analysis from the classified and tabulated data. The database sharing business management company then makes it possible for a user, a hospital, a research organization, or the like to view or acquire the results of the analysis via the Internet 100. The results of the analysis may include such things as, for example, recent illnesses, treatment, trends in prescribed medications, and the like, as well as rankings of hospitals based on the performance of hospitals as regards their treatment and cost. Each time a user or the like views the analysis results, the database terminal 20 charges the viewer.

As has been described above, according to the present embodiment, because data from a number of hospitals can be collected via the Internet 100, this data can then be classified and tabulated, and the results when the data is analyzed can be made available via the Internet 100, users, hospitals, research organizations and the like are able to promptly view and acquire the latest analysis results.

Fifth Embodiment

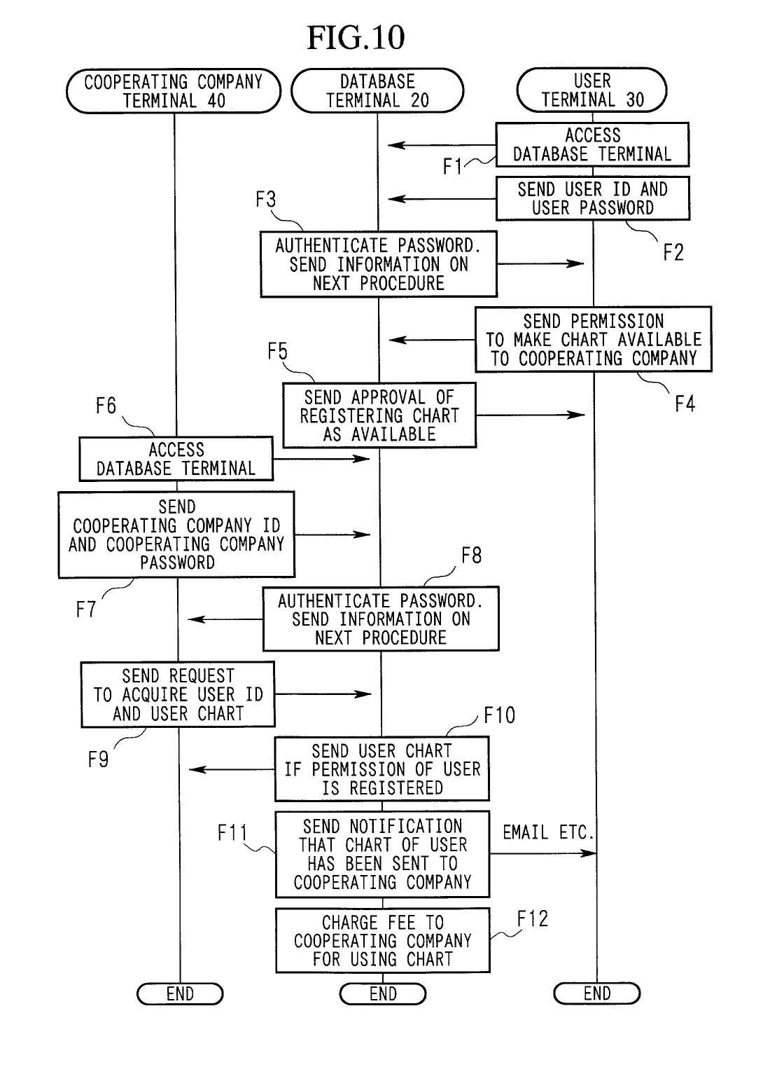

A description will be given next of the method for sharing information about the medical care of an individual according to the fifth embodiment of the present invention with reference made to FIGS. 9 and 10. FIG. 9 is a block diagram showing the structure used in the method for sharing information about the medical care of an individual according to the fifth embodiment of the present invention. FIG. 10 is a flow chart showing the procedure of the method for sharing information about the medical care of an individual according to the fifth embodiment of the present invention.

The fifth embodiment has substantially the same network structure and procedure as the above described first embodiment. However, it is different from the first embodiment in that, with the permission of the user, not only hospitals, but also companies and organizations and the like that are cooperating in business with the database sharing business management company are also able to acquire the chart of the user.

As is shown in FIG. 9, the method for sharing information about the medical care of an individual according to the fifth embodiment of the present invention uses a plurality of hospital terminals 10, a database terminal 20, a plurality of user terminals 30, a plurality of cooperating company terminals 40, and a communication network 100 such as the internet that connects these all together.

The procedure of the method for sharing information about the medical care of an individual according to the fifth embodiment will now be described.

As is shown in FIG. 10, a user who has completed registration (referred to below as User J) uses the user terminal 30 to access the database terminal 20 via the Internet 100 (step F1).

Next, User J sends his or her user ID and user password to the database terminal 20 (step F2).

In response, the database terminal 20 authenticates User J by the user ID and the user password. If the user ID and the user password are correct, the database terminal 20 sends information concerning the next procedure to the user terminal 30 (step F3). Consequently, the contents of this transmission are displayed on the screen of the hospital terminal 10.

In accordance with the information concerning the next procedure displayed on the screen of the user terminal 30, User J sends permission to the database terminal 20 for the chart of User J to be made available to a particular cooperating company (referred to below as Cooperating Company K) (step F4).

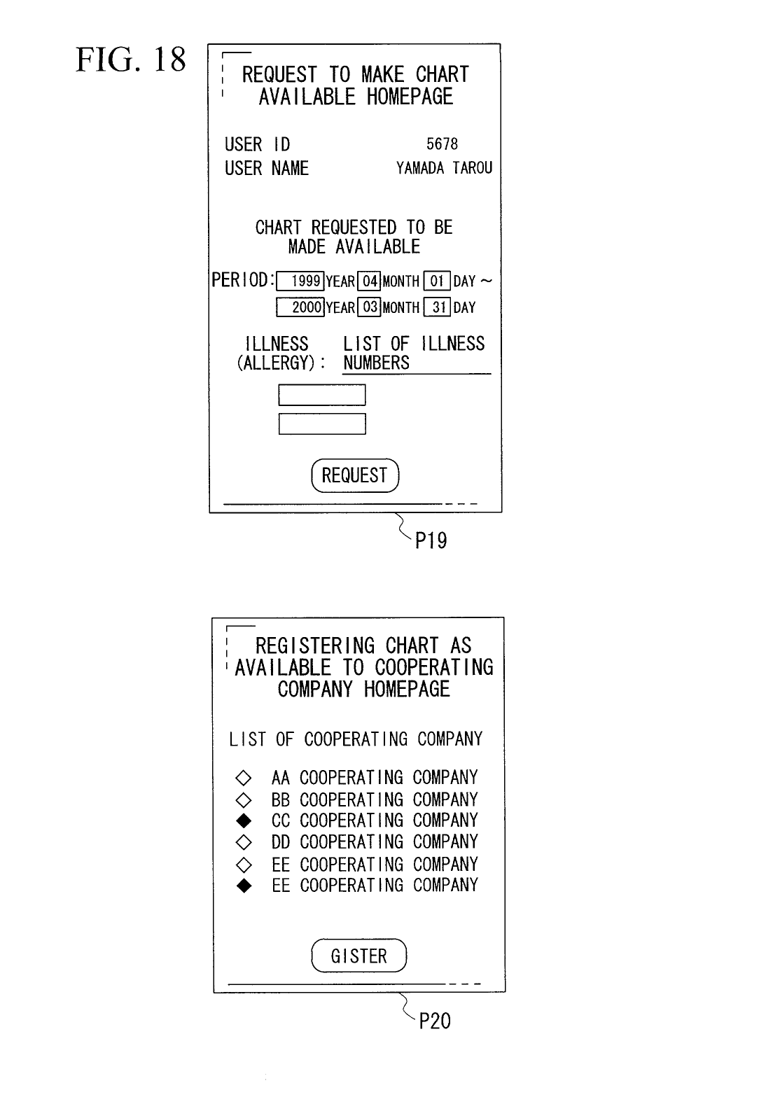

In response, the database terminal 20 sends their approval of the registering of the chart of User J as one that has been made available to the user terminal 30 (step F5). This permission to make the chart available is a procedure that can be carried out on, for example, a homepage such as those shown in FIGS. 13, 16, and 18. Namely, User J who has accessed the Chart Sharing Service Homepage P1 clicks on “User Service Contents”. If the user ID and user password have not been input, a request is made for these to be input and User J therefore make the inputs as requested. This causes the screen to jump to the Chart Sharing Service Homepage for Users P14. On this page, User J clicks on “Registering Chart as Available to Cooperating Company” from the menu. This causes the screen to jump to the Registering Chart as Available to Cooperating Company Homepage P20. On this page, User J selects the cooperating company to which permission is to be given and clicks on the “Register” button. As a result, a registration approval display screen (not illustrated) containing a message such as “Approved registration of chart as available to XX Company” is displayed on the screen of the user terminal 30 and the registration procedure is completed.

Thereafter, Cooperating Company K uses the cooperating company terminal 40 to access the database terminal 20 via the Internet 100 (step F6).

Next, Cooperating Company K sends the cooperating company ID and the cooperating company password received beforehand from the database sharing service business management company to the database terminal 20 (step F7). The database terminal 20 authenticates the cooperating company K using the cooperating company ID and the cooperating company password. If the cooperating company ID and the cooperating company password are correct, the database terminal 20 sends information concerning the next procedure to the cooperating company terminal 40 (step F8). As a result, the contents of the transmission are displayed on the screen of the cooperating company terminal 40.

Next, in accordance with the information concerning the next procedure displayed on the screen of the cooperating company terminal 40, Cooperating Company K sends the user ID and the user chart they wish to acquire to the database terminal 20 (step F9).

In response, because user J has registered the chart as being available for viewing by cooperating Company K, the database terminal 20 sends the chart of User J to the cooperating company terminal 40 (step F10).

Next, the database terminal 20 notifies User J by email or the like that the chart of User J has been sent to the cooperating company (step F11).

Next, the database terminal 20 charges Cooperating Company K the fee for viewing the chart (step F12).

This acquiring of a chart is a procedure that can be carried out on a homepage such as those shown in FIGS. 13, 15, and 16. Namely, Cooperating Company K which has accessed the Chart Sharing Service Homepage P1 clicks on “Cooperating Company Service Contents”. If the cooperating company ID and cooperating company password have not been input, a request is made for these to be input and Cooperating Company K therefore make the inputs as requested. This causes the screen to jump to the Chart Sharing Service Homepage for Cooperating Companies P12. On this page, Cooperating Company K inputs the user ID of User J. This causes the screen to jump to the Cooperating Company Chart Acquiring Service Homepage P13. On this page, the chart database allocated to User J is displayed. This database may have a directory tree structure, for example, as is shown in the drawings, and is displayed as a structure in which it is possible to select various classifications on the display such as “select by hospital”, “select by illness”, select by date”, etc. Cooperating Company K opens a folder and then opens the desired chart file by double clicking it or the like. As a result, for example, the page P13 is divided and the contents of the selected chart file are displayed on the right hand three fourths of the page. This may be displayed, for example, in a structure such as that shown in the Chart Display Homepage P10 (except for the Update button). Cooperating Company K views and utilizes charts by repeatedly performing the above operation.

As has been described above, according to the present embodiment, because a company or organization other than a hospital is able to acquire with the permission of a user the chart of that user via the Internet 100, it is made easier for those companies and organizations to run their businesses. For example, an insurance company is able to request that the chart of a user be made available as a condition of that user obtaining an insurance policy. In addition, the acquiring process is also speeded up. Moreover, a health insurance society is able to examine the contents of treatment and hospital charges extremely easily.

Sixth Embodiment

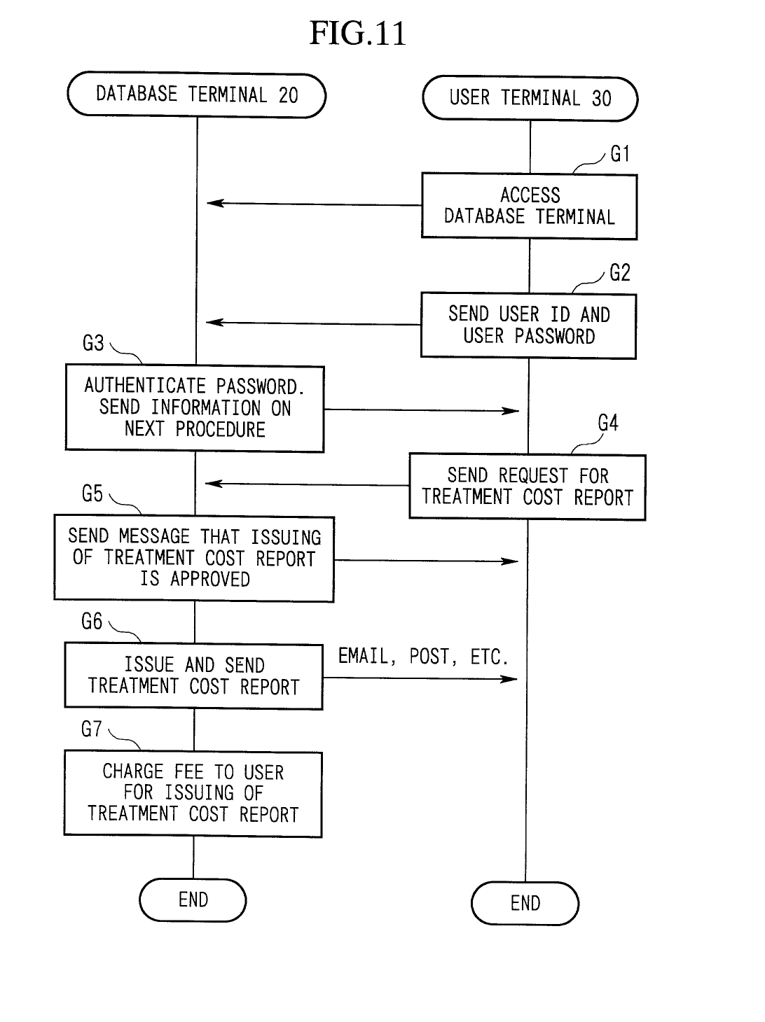

A description will be given next of the method for sharing information about the medical care of an individual according to the sixth embodiment of the present invention with reference made to FIGS. 1, 11, 13, 16 and 17. FIG. 11 is a flow chart showing the procedure of the method for sharing information about the medical care of an individual according to the sixth embodiment of the present invention.

The sixth embodiment has substantially the same network structure and procedure as the above described first embodiment. However, it is different from the first embodiment in that, based on the chart of a user that is saved in the database terminal 20, the chart or the details of the cost of treatment and the like desired by the user are automatically issued.

The procedure of the method for sharing information about the medical care of an individual according to the sixth embodiment is described below.

As is shown in FIG. 11, a user who has completed the registration procedure (this user will be referred to below as User L) uses the user terminal 30 to access the database terminal 20 via the internet 100 (step G1).

Next, the User L sends his or her user ID and user password to the database terminal 20 (step G2). The database terminal 20 then authenticates User L by the user ID and the user password. If the user ID and the user password are correct, the database terminal 20 sends information about the next procedure to the user terminal 30 (step G3). This causes the contents of the transmission to be displayed on the screen of the user terminal 30.

Next, in accordance with the information about the next procedure displayed on the screen of the user terminal 30, User L specifies the range of the information to be used for creating the report and the addressee and sends a message to the effect that User L wishes for a treatment cost report to be issued to the database terminal 20 (step G4). In response to this, the database terminal 20 sends an approval for the issuing of the user's treatment cost report to the user terminal 30 (step G5).

Next, the database terminal 20 issues a report on the treatment cost asked for by user L and sends this to User L by email or by postal mail or the like (step G6).

If User L needs to submit the issued treatment cost report to a public organization or company, then if permission is given for the transmission of the treatment cost report to the public organization or the like via the Internet 100, the database terminal 20 directly transmits the treatment cost report to the public organization specified by the User L. At this time, the electronic signature of a person who can verify the authenticity of the treatment cost report is annotated to the treatment cost report.

Next, User L is charged the fee for the issuing of the treatment cost report.

As has been described above, according to the present embodiment, because a treatment cost report or the like as desired by the user is collated and automatically issued on the basis of the user's chart, not only is there no need for the user to keep hold of receipts for treatment costs and the like or to prepare complicated treatment cost reports, but the processing performed by the public organization and the like that receives the treatment cost report is also simplified. This issuing of the treatment cost report is a procedure that can be performed on a homepage such as those shown in FIGS. 13, 16, and 17, for example. Namely, User L who has accessed the Chart Sharing Service Homepage P1 clicks on “User Service Contents”. If the user ID and user password have not been input, a request is made for these to be input and User L therefore make the inputs as requested. This causes the screen to jump to the Chart Sharing Service Homepage for Users P14. On this page, User L clicks on “Issue Treatment Cost Report” from the menu. This causes the screen to jump to the Treatment Cost Report Issuing Service Homepage P18. On this page, User L inputs the addressee (either User L or another person), the sending method (i.e. by normal post, by electronic post, or the like), and the range to be used for preparing the treatment cost report. The input of the addressee can be performed by directly inputting the address or by clicking on the “List of Addressees” so as to cause the list of addressees (not illustrated) to be displayed, and then selecting an addressee from the list. The input of the range to be used for preparing the treatment cost report is done by inputting a chart number, a period, or the like. The tree structure chart database allocated to User L is also displayed on the homepage P18. It is also possible to select the chart and period to be used by using this database directory.

Seventh Embodiment

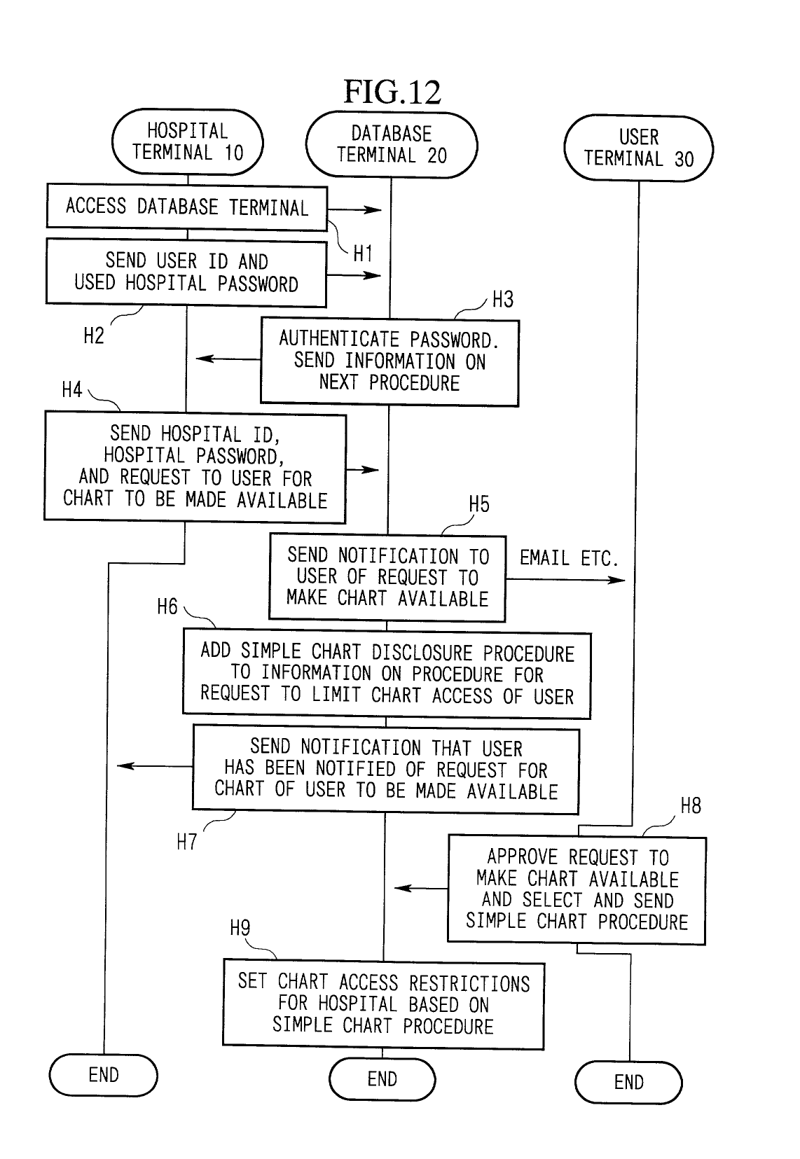

A description will be given next of the method for sharing information about the medical care of an individual according to the seventh embodiment of the present invention with reference made to FIGS. 1, 12, 13, 15, 16, 17 and 18. FIG. 12 is a flow chart showing the procedure of the method for sharing information about the medical care of an individual according to the seventh embodiment of the present invention.

The seventh embodiment has substantially the same network structure and procedure as the above described first embodiment. However, it is different from the first embodiment in the following points. Namely, in that the hospital sends a request for the chart on which is recorded information needed for the treatment of a user to be made available to the database terminal 20; in that the database terminal 20 sends notification to the user by email or the like of the request for the chart to be made available in response to the request from the hospital for the chart to be made available; in that, after the database terminal 20 has sent notification to the user of the request for the chart to be made available, the database terminal 20 notifies the hospital terminal 10 that notification has been sent to the user of the request for the chart to be made available; and in that, when the user approves the request by the hospital for the chart to be made available, the chart access restrictions can be simply altered.

The procedure of the method for sharing information about the medical care of an individual according to the seventh embodiment will now be described.

As is shown in FIG. 12, a hospital that has completed the registration procedure (referred to below as Hospital J) uses the hospital terminal 10 to access the database terminal 20 via the Internet 100 (step H1).

Next, Hospital J sends the user ID and used hospital password (or the hospital ID and hospital password) of a user (referred to below as User M) who has completed registration and who is coming or is about to come to Hospital J for treatment (step H2).

In response, the database terminal 20 then authenticates User M by the user ID and the used hospital password. If the user ID and the used hospital password are correct, the database terminal 20 sends information about the next procedure to the hospital terminal 10 (step H3). This causes the contents of the transmission to be displayed on the screen of the hospital terminal 10.

Next, in accordance with the information about the next procedure displayed on the screen of the hospital terminal 10, the hospital ID and the hospital password are selected (if the hospital ID and the hospital password have already been sent in step H2, then the user ID of User M and the used hospital ID are selected) together with the range (i.e. type of illness, period, or the like) of the chart on which the information needed for the treatment of User M is recorded (or which might possibly be recorded), and the request for the chart covering the range selected for User M to be made available is sent to the database terminal 20 (step H4).

In response to this, the database terminal 20 authenticates Hospital J by the hospital ID and the hospital password. If the hospital ID and the hospital password are correct, the database terminal 20 notifies User M by email or the like that Hospital J is requesting that the chart of User M be made available (step H5).

This request for the chart to be made available is a procedure that can be performed on a homepage such as those shown in FIGS. 13, 15, and 18, for example. Namely, Hospital J that has accessed the Chart Sharing Service Homepage P1 clicks on “Hospital Service Contents”. If the hospital ID and hospital password have not been input, a request is made asking for their input. Hospital J then makes the inputs as requested. This causes the screen to jump to the Chart Sharing Service Homepage for Hospitals P8. On this page, Hospital J inputs the password of the hospital being used and the user ID of User M. In response, the screen jumps to Hospital Chart Obtaining and Other Services Homepage P9. Next, Hospital J clicks on “Request to Make Chart Available” on this page. In response, the screen jumps to the Request to Make Chart Available Homepage P19. On this page, Hospital J inputs the period or the type of illness of the chart it wishes to be made available. This input of the illness number can be changed by clicking on the “List of Illness Numbers” on the Request to Make Chart Available Homepage P19 so as to cause the list of illness numbers (not illustrated) to be displayed on the screen, and then selecting an illness from the list by clicking the illness on the list. Hospital J that has input the range to be covered of the chart it wishes to be made available finally clicks on the “Request” button. This causes a request approval screen (not illustrated) that contains a message such as “Request for chart for User M to be made available is received” to be displayed on the screen of the hospital terminal 10 and the procedure followed for a request for making a chart available is completed.

Next, the database terminal 20 prepares a “Simple Chart Disclosure Procedure” based on the request by Hospital J to make the chart of User M available. If User M sends a desire to restrict the access of Hospital J to the chart, the “Simple Chart Disclosure Procedure” is added to the information of the procedure sent to the user terminal 30 (step H6). As described below, this “Simple Chart Disclosure Procedure” is a procedure performed when the request by Hospital J for the chart to be made available is approved for the range as requested by the hospital.

Next, the database terminal 20 notifies the hospital terminal 10 by email or the like that notification of the request for the chart to be made available has been made to User M (step H7).

Next, the same operations as in the third embodiment are performed until the database terminal 20 sends information on the next procedure as a response to the wish of the user to restrict chart access (i.e. steps E1 to E5). This causes the procedure information necessary to restrict access to the chart by the hospital to be displayed on the screen of the user terminal 30.

Next, User M selects from the procedure information displayed on the screen of the user terminal 30 the password of the hospital being used whose chart access the user wishes to restrict (and which has been given to Hospital J) and the “Simple Chart Disclosure Procedure” prepared on the basis of the request by Hospital J for the chart of User M to be made available, and these are sent to the database terminal 20 (step H8).

Next, the database terminal 20 sets the chart access restrictions when the chart of User M (whose availability was requested by Hospital J) is made available for Hospital J using the used hospital password and the “Simple Chart Disclosure Procedure” (step H9). This setting of the access restrictions is a procedure that can be performed on a homepage such as those shown in FIGS. 13, 16, and 17, for example. Namely, User M who has accessed the Chart Sharing Service Homepage P1 clicks on “User Service Contents”. If the user ID and user password have not been input, a request is made for these to be input and User M therefore make the inputs as requested. This causes the screen to jump to the Chart Sharing Service Homepage for Users P14. On this page, User M clicks on “Restrict Chart Access” from the menu. This causes the screen to jump to the Chart Access Restricting Homepage P15. On this page, User M selects Hospital J. This causes the Chart Access Restriction Setting Homepage P16 for Hospital J to open up. On this page, User M checks the checkbox for approving the chart disclosure request by Hospital J by clicking on it and then clicks on the “Set” button (i.e. selects “Simple Chart Disclosure Request”). As a result, Hospital J is able to access the chart within the range requested by Hospital J.

As has been described above, according to the present embodiment, it is possible for a hospital to notify a user as to the chart needed for the treatment of the user and for the user to make an appropriate response to his notification.

Eighth Embodiment

A description will be given next of the method for sharing information about the medical care of an individual according to the eighth embodiment of the present invention with reference made to FIGS. 13, 16, and 18. In the above seventh embodiment, a chart disclosure request receiving service is performed for a hospital. In the same way, it is also possible for a chart disclosure request receiving service to be performed for a cooperating company. In this case, the disclosure request by a cooperating company is a procedure that can be performed on a homepage such as those shown in FIGS. 13, 16, and 18, for example. Namely, Cooperating Company N that has accessed the Chart Sharing Service Homepage P1 clicks on “Cooperating Company Service Contents”. If the cooperating company ID and cooperating company password have not been input, a request is made for these to be input and Cooperating Company N therefore make the inputs as requested. This causes the screen to jump to the Chart Sharing Service Homepage for Cooperating Companies P12. On this page, Cooperating Company N inputs the user ID of User M. This causes the screen to jump to the Cooperating Company Chart Acquiring Service Homepage P13. Next, Cooperating Company N clicks on “Chart Disclosure Request” on this page. As a result, the screen jumps to the Request to Make Chart Available Homepage P19. On this page, Cooperating Company N inputs the period or the type of illness of the chart it wishes to be made available. This input of the illness number can be changed by clicking on the “List of Illness Numbers” on the Request to Make Chart Available Homepage P19 so as to cause the list of illness numbers (not illustrated) to be displayed on the screen, and then selecting an illness from the list by clicking the illness on the list. Cooperating Company N that has input the range to be covered of the chart it wishes to be made available finally clicks on the “Request” button. This causes a request approval screen (not illustrated) that contains a message such as “Request for chart for User M to be made available is received” to be displayed on the screen of the hospital terminal 10 and the procedure followed for a request for making a chart available is completed.

The remainder of the procedure is the same as is carried out in the above seventh embodiment.

According to the method for sharing information about the medical care of an individual according to the present invention, when a hospital accesses a database terminal in order to acquire or save information about the medical care of an individual in the database, the second password allocated to the user is required. Therefore, the hospital needs to learn the second password from the user. The hospital is able to learn the user ID and second password from the user, acquire individual treatment information from the database, use this information, and save new individual treatment information in the database. However, thereafter, if the user alters the second password, the hospital is not able to acquire individual treatment information from the database, use the information, and save new individual treatment information in the database. Accordingly, the user has the authority to decide who is shown the individual treatment information of the user him or herself or of a person under the care of the user, and when this person is shown this information. In addition, the user is able to view the individual treatment information saved in a space for storing individual treatment information in the database acquired by the user him or herself. Moreover, a system can be provided which encourages participants to join up due to its advantages for the user such as the user being able to be issued reports on treatment costs and the like.

Whoever is in charge of the database (i.e. the database sharing business management company) is able to charge the user a registration fee when necessary; allocate the user a user ID, a user password, a second password, and space for storing individual treatment information in the database; enable the user to use the database; charge the user a fee for that use; charge the hospital or cooperating company a registration fee when necessary; allocate them an ID and password; allow the hospital or cooperating company to use the database with the permission of the user; and charge them a fee for that use. It is also possible for the individual treatment information accumulated in the database to be provided for use by a third party such as a cooperating company with the permission of the individual, and for the treatment information to be made more valuable by being classified and tabulated. Therefore, by corresponding the relevant registration fee or usage fee with the database management fund, it is possible to reduce the cost shouldered by the hospital compared with when the individual treatment information such as clinical charts or the like is placed on a database by the hospital administration.

Consequently, according to the method for sharing information about the medical treatment of an individual of the present invention, it is possible to reduce the costs borne by the hospital and thereby promoting an increase the number of participating hospitals. It is also possible for a user to view individual medical care information such as the clinical chart, the extent of the treatment, the treatment costs, what medicines have been prescribed and the like of the user him or herself or of another person under the care of the user (for example, a juvenile or a severely handicapped person). It is also possible for the hospital to be able to prescribe treatment and medicines appropriate for each individual person after considering the treatment information for that person such as past clinical charts and the like and for the patient to be able to receive such appropriate treatment and medicine prescriptions.

What is claimed is:

1. A method for sharing information concerning medical treatment of an individual that uses a network system in which a plurality of hospital terminals, a plurality of user terminals, and a database terminal for managing a database of information concerning medical treatment of an individual are mutually connected via a communication network,
wherein information concerning medical treatment of an individual is shared after a user has acquired space for storing information concerning medical treatment of an individual and has acquired means for placing restrictions on and removing restrictions from access to the storage space by third parties including hospitals.

2. A method for sharing information concerning medical treatment of an individual that uses a network system in which a plurality of hospital terminals, a plurality of user terminals, and a database terminal for managing a database of information concerning medical treatment of an individual are mutually connected via a communication network, wherein
a hospital acquires a hospital ID and a hospital password,
a user acquires a user ID, a user password, a second password, and space for storing information concerning medical treatment of an individual in a database, and
a hospital acquires individual medical treatment information from the database using the user ID, the second password, the hospital ID, and the hospital password as keys, and stores updated individual medical treatment information in the database using the user ID, the second password, the hospital ID, and the hospital password as keys.

3. The method for sharing information concerning medical treatment of an individual according to claim 2, wherein the user views individual medical treatment information on the database using the user ID and the user password as keys.

4. The method for sharing information concerning medical treatment of an individual according to claim 2, wherein a charge is levied on the hospital when the hospital acquires individual medical treatment information from the database.

5. The method for sharing information concerning medical treatment of an individual according to claim 2, wherein a charge is levied on the hospital when the hospital saves updated individual medical treatment information in the database.

6. The method for sharing information concerning medical treatment of an individual according to claim 3, wherein a charge is levied on the user when the user views individual medical treatment information.

7. The method for sharing information concerning medical treatment of an individual according to claim 2, wherein the user password is altered using the user ID and the user password as keys.

8. The method for sharing information concerning medical treatment of an individual according to claim 2, wherein the second password is altered using the user ID and the user password as keys.

9. The method for sharing information concerning medical treatment of an individual according to claim 2, wherein, if updated individual medical treatment information is not saved in the database within a predetermined time after the hospital has acquired the individual medical treatment information from the database, notification is sent to the hospital requesting updated individual medical treatment information.

10. The method for sharing information concerning medical treatment of an individual according to claim 2, wherein notification of the updating of the individual medical treatment information is sent to the user when updated individual medical treatment information is saved in the database.

11. The method for sharing information concerning medical treatment of an individual according to claim 2, wherein the user specifies a hospital and restricts access by the specified hospital to the space where the individual medical treatment information of the user is stored using the user ID and the user password as keys.

12. The method for sharing information concerning medical treatment of an individual according to claim 2, wherein, a cooperating company terminal that is used by a cooperating company that is in cooperation with whoever is managing the database is incorporated into the network system and, using this network system, the cooperating company acquires a cooperating company ID and cooperating company password and, after the user has given permission for the individual medical treatment information to be made available to the cooperating company using the user ID and user password as keys, the cooperating company acquires the individual medical treatment information of the user from the database using the cooperating company ID and cooperating company password as keys.

13. The method for sharing information concerning medical treatment of an individual according to claim 12, wherein a charge is levied on the cooperating company when the cooperating company acquires individual medical treatment information from the database.

14. The method for sharing information concerning medical treatment of an individual according to claim 2, wherein treatment costs are include in the individual medical treatment information.

15. The method for sharing information concerning medical treatment of an individual according to claim 14, wherein the user is issued with a treatment cost report calculated from the treatment costs on the database using the user ID and user password as keys.

16. The method for sharing information concerning medical treatment of an individual according to claim 2, wherein the database terminal receives a request sent from the hospital terminal or from the cooperating company terminal for the individual medical treatment information of the user to be made available and transfers the request to the user terminal of the user, and also receives an approval from the user terminal regarding the request for the individual medical treatment information to be made available.

17. A database terminal for information concerning medical treatment of an individual comprising:
a computer program for sending a user password and a second password to a user terminal; and
a computer program that requests the second password when a person other than the user accesses the space where the individual medical treatment information is stored.

18. The method for sharing information concerning medical treatment of an individual according to claim 17, wherein there is further provided a computer program for requesting the user password when the second password is altered.

19. A database terminal for information concerning medical treatment of an individual comprising:
a computer program that counts a predetermined time from the point when individual medical treatment information is sent to a hospital terminal and determines whether or not updated individual medical treatment information has been received, and if a precondition of the predetermined time having passed and the updated individual medical treatment information not having been received is met, the computer program automatically sends a notification requesting an update of the individual medical treatment information to the hospital terminal.

20. A database terminal for information concerning medical treatment of an individual comprising:
a computer program that determines whether or not updated individual medical treatment information has been received, and if a precondition of the updated individual medical treatment information having been received is met, the computer program automatically sends a notification requesting an update of the individual medical treatment information to the hospital terminal.

21. A database terminal for information concerning medical treatment of an individual comprising:
a computer program that follows a routine to a step in which set conditions concerning access restrictions on the space where the individual medical treatment information is stored are altered if a precondition of the user password having been requested and the requested user password having been received is met.
